(19) United States
(12) Patent Application Publication
(10) Pub. No.: US 2013/0282839 A1
(43) Pub. Date: Oct. 24, 2013

(54) SYSTEMS AND METHODS FOR AUTOMATICALLY MESSAGING A CONTACT IN A SOCIAL NETWORK

(71) Applicant: Jose Alcala, La Mirada, CA (US)

(72) Inventor: Jose Alcala, La Mirada, CA (US)

(73) Assignee: UNITED VIDEO PROPERTIES, INC., Santa Clara, CA (US)

(21) Appl. No.: 13/453,506

(22) Filed: Apr. 23, 2012

(51) Int. Cl. G06F 15/16

(52) U.S. Cl. 709/206

(57) ABSTRACT

Embodiments provide methods and systems for automatically sending a communication to a contact in a social network. In some embodiments, a social network server receives a user selection of a competitor involved in a competition about which the user would like to send messages. The social network server identifies a media asset that is associated with the competitor, such as a video clip of the competition. The social network server then identifies one of the user's contacts who is also interested in the competition. The social network server automatically transmits the media asset to the identified contact.

### BACKGROUND

Social network services focus on building social networks or social relations among people. Popular social networking services include Facebook™, MySpace™, and Twitter™. Users can send messages to other users within these social networks using, for example, public posts or private messages. Users can also share content by posting content to their user profiles or to group profiles so that the content can be viewed by other users.

Using these content sharing mechanisms, social networks enable users to share content that is of interest to themselves and their contacts. Such content may be related to competitions such as athletic competitions or reality television competitions. Social networks also allow users to view and engage with content from competitors, such as sports teams, dancers, or vocalists, though the competitors' user profiles and content postings. When content gets posted on a social network or elsewhere on the Internet, users currently have to manually locate the content and interact with it in some way (e.g., reposting the content or sending a link to the content to their contacts) if they want to share it with their contacts.

### SUMMARY

In order to share content with other users faster and with less effort, methods and systems are provided herein for automated messaging within a social network. By automatically identifying content, identifying one or more contacts to share it with, and sharing the content with the contacts, a user can be sure that he is one of the first to post content of interest to his contacts.

In some embodiments, a social network server receives a user selection of a competitor or competition about which the user would like to send messages. The competitor may be, for example, a sports team, an athlete, or a performer who is involved in a competition, such as a sports game or a reality television show. The social network server identifies a media asset that is associated with the competitor, such as a video clip of the competition. The social network server then identifies one of the user's contacts who is also interested in the competition. The social network server automatically transmits the media asset to the identified contact.

In some embodiments, the user and the contact favor different competitors in the competition. For example, the user may support one football team, such as the New England Patriots, and the contact may support a different football team, such as New York Jets. The content of the media asset may be desirable for the user and undesirable for the contact, or vice versa. For example, the media asset may be a video of the New England Patriots scoring a touchdown. In this case, the media asset may be accompanied by a message mocking the New York Jets or rooting for the New England Patriots.

In some embodiments, the user and the contact favor the same competitor or aligned competitors in the competition. For example, both the user and the contact may root for the New York Jets, or the user and the contact may root for different players who play for the New York Jets. The content of the media asset may be desirable for both the user and the contact or undesirable for both the user and the contact. For example, the media asset may be a video of the New York Jets scoring a touchdown. In this case, the media asset may be accompanied by a message that is rooting for the New York Jets.

In some embodiments, the contact(s) to whom media assets are sent are inputted by the user. In other embodiments, the social network server automatically identifies one or more of the user's contacts to send the message to. To identify a contact to send a media asset related to a particular competition, the social network server could compare the competitors involved in the competition to the interests of the user's contacts. The social network server selects one or more of the contacts who are interested in a competitor involved in the competition. Data analytics or text analytics may be performed on data that the social network associates with the contacts to identify the contacts' interests.

In some embodiments, the media assets are identified by the social network server. The social network server receives a media asset feed containing data related to competitions. For example, the social network server may receive a feed containing video clips from football games. The social network server compares the competitors in the media assets to the competitors that the user is interested in to find media assets that the user would want to share with one or more contacts.

### BRIEF DESCRIPTION OF THE DRAWINGS

The above and other objects and advantages of the invention will be apparent upon consideration of the following detailed description, taken in conjunction with the accompanying drawings, in which like reference characters refer to like parts throughout, and in which:

FIG. 1 shows an illustrative display screen that may be used to provide media guidance application listings and other media guidance information in accordance with an embodiment of the invention;

FIG. 2 shows another illustrative display screen that may be used to provide media guidance application listings in accordance with an embodiment of the invention;

FIG. 3 is a block diagram of an illustrative user equipment device in accordance with an embodiment of the invention;

FIG. 4A is a block diagram of an illustrative interactive media system in accordance with an embodiment of the invention;

FIG. 4B is a block diagram of an illustrative social network server in accordance with an embodiment of the invention;

FIG. 5 is an illustrative display screen for displaying public posts and items that a user has indicated he likes in a social network in accordance with an embodiment of the invention;

FIG. 6 is an illustrative display screen for displaying items that a user of a social network can indicate that he likes in accordance with an embodiment of the invention;

FIG. 7 is an illustrative display screen showing selectable automated messaging setup options in accordance with an embodiment of the invention;

FIG. 8 is an illustrative display screen showing a selected set of automated messaging setup options in accordance with an embodiment of the invention;

FIG. 9 is an illustrative display screen showing additional selectable automated messaging setup options in accordance with an embodiment of the invention;

FIG. 10 is an illustrative display screen showing a publicly posted automated message generated based on the selectable automated messaging setup options of FIGS. 8 and 9, in accordance with an embodiment of the invention;

FIG. 11 is an illustrative display screen showing a private automated message in accordance with another embodiment of the invention;

FIG. 12 is an illustrative display screen showing public posts from a social network user that can be liked by another user of a social network, in accordance with an embodiment of the invention;

FIG. 13 is an illustrative display screen showing an automated messaging setup overlay screen in accordance with an embodiment of the invention;

FIG. 14 is an illustrative display screen showing a publicly posted automated message generated based on the selectable automated messaging setup options of FIG. 13 in accordance with an embodiment of the invention;

FIG. 15 is an illustrative display screen showing a second automated messaging setup overlay screen in accordance with an embodiment of the invention;

FIG. 16 is an illustrative display screen showing a publicly posted automated message generated based on the selectable automated messaging setup options of FIG. 15 in accordance with an embodiment of the invention;

FIG. 17 shows an illustrative process for setting up criteria for generating automated messages related to events in accordance with an embodiment of the invention;

FIG. 18 shows an illustrative process for generating an automated message based on messaging criteria and sending the message to a contact in a social network in accordance with an embodiment of the invention; and

FIG. 19 shows another illustrative process for generating and sending a message to a contact of a user of a social network in accordance with an embodiment of the invention.

### DETAILED DESCRIPTION OF EMBODIMENTS

The amount of content available to users in any given content delivery system can be substantial. Consequently, many users desire a form of media guidance through an interface that allows users to efficiently navigate content selections and easily identify content that they may desire. An application that provides such guidance is referred to herein as an interactive media guidance application or, sometimes, a media guidance application or a guidance application.

Interactive media guidance applications may take various forms depending on the content for which they provide guidance. One typical type of media guidance application is an interactive television program guide. Interactive television program guides (sometimes referred to as electronic program guides) are well-known guidance applications that, among other things, allow users to navigate among and locate many types of content. As referred to herein, the term “content” should be understood to mean an electronically consumable user asset, such as television programming, as well as pay-per-view programs, on-demand programs (as in video-on-demand (VOD) systems), Internet content (e.g., streaming content, downloadable content, Webcasts, etc.), video clips, audio, content information, pictures, rotating images, documents, playlists, websites, articles, books, electronic books, blogs, advertisements, chat sessions, social media, applications, games, and/or any other media or multimedia and/or combination of the same. Guidance applications also allow users to navigate among and locate content. As referred to herein, the term “multimedia” should be understood to mean content that utilizes at least two different content forms described above, for example, text, audio, images, video, or interactivity content forms. Content may be recorded, played, displayed or accessed by user equipment devices, but can also be part of a live performance.

With the advent of the Internet, mobile computing, and high-speed wireless networks, users are accessing media on user equipment devices on which they traditionally did not. As referred to herein, the phrase “user equipment device,” “user equipment,” “user device,” “electronic device,” “electronic equipment,” “media equipment device,” or “media device” should be understood to mean any device for accessing the content described above, such as a television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a hand-held computer, a stationary telephone, a personal digital assistant (PDA), a mobile telephone, a portable video player, a portable music player, a portable gaming machine, a smart phone, or any other television equipment, computing equipment, or wireless device, and/or combination of the same. In some embodiments, the user equipment device may have a front facing screen and a rear facing screen, multiple front screens, or multiple angled screens. In some embodiments, the user equipment device may have a front facing camera and/or a rear facing camera. On these user equipment devices, users may be able to navigate among and locate the same content available through a television. Consequently, media guidance may be available on these devices, as well. The guidance provided may be for content available only through a television, for content available only through one or more of other types of user equipment devices, or for content available both through a television and one or more of the other types of user equipment devices. The media guidance applications may be provided as on-line applications (i.e., provided on a web-site), or as stand-alone applications or clients on user equipment devices. Various devices and platforms that may implement media guidance applications are described in more detail below.

One of the functions of the media guidance application is to provide media guidance data to users. As referred to herein, the phrase, “media guidance data” or “guidance data” should be understood to mean any data related to content, such as media listings, media-related information (e.g., broadcast times, broadcast channels, titles, descriptions, ratings information (e.g., parental control ratings, critic's ratings, etc.), genre or category information, actor information, logo data for broadcasters' or providers' logos, etc.), media format (e.g., standard definition, high definition, 3D, etc.), advertisement information (e.g., text, images, media clips, etc.), on-demand information, blogs, websites, and any other type of guidance data that is helpful for a user to navigate among and locate desired content selections.

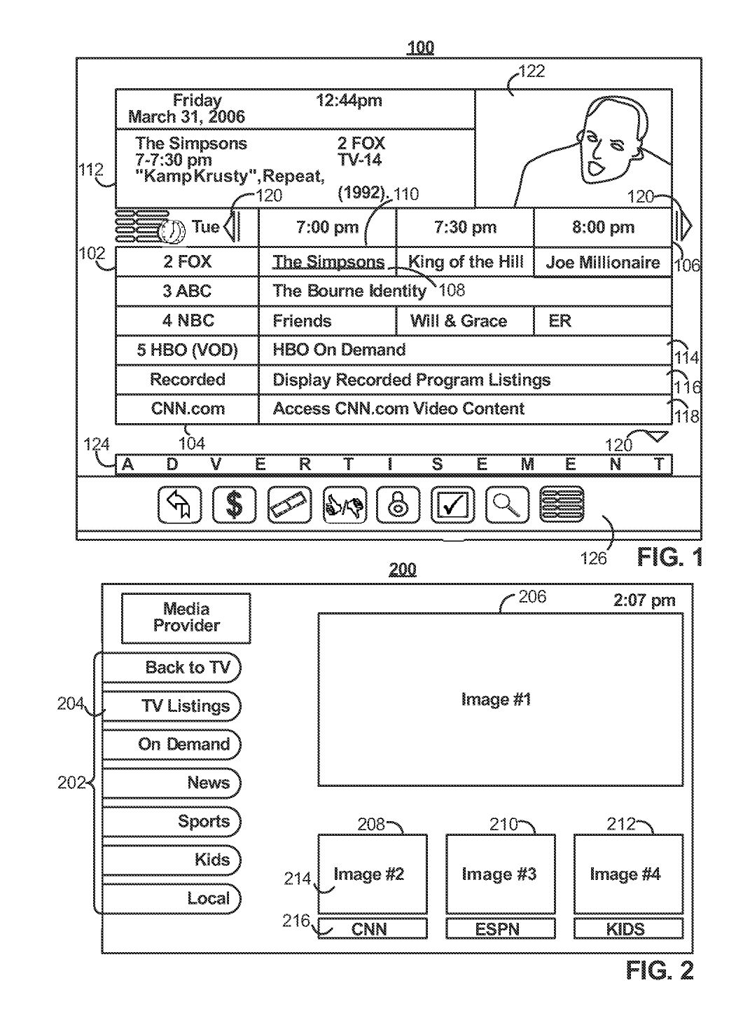

FIGS. 1-2 show illustrative display screens that may be used to provide media guidance data. The display screens shown in FIGS. 1-2 and 5-16 may be implemented on any suitable user equipment device or platform. While the displays of FIGS. 1-2 and 5-16 are illustrated as full screen displays, they may also be fully or partially overlaid over content being displayed. A user may indicate a desire to access content information by selecting a selectable option provided in a display screen (e.g., a menu option, a listings option, an icon, a hyperlink, etc.) or pressing a dedicated button (e.g., a GUIDE button) on a remote control or other user input interface or device. In response to the user's indication, the media guidance application may provide a display screen with media guidance data organized in one of several ways, such as by time and channel in a grid, by time, by channel, by source, by content type, by category (e.g., movies, sports, news, children, or other categories of programming), or other predefined, user-defined, or other organization criteria. The organization of the media guidance data is determined by guidance application data. As referred to herein, the phrase, “guidance application data” should be understood to mean data used in operating the guidance application, such as program information, guidance application settings, user preferences, or user profile information.

FIG. 1 shows illustrative grid program listings display 100 arranged by time and channel that also enables access to different types of content in a single display. Display 100 may include grid 102 with: (1) a column of channel/content type identifiers 104, where each channel/content type identifier (which is a cell in the column) identifies a different channel or content type available; and (2) a row of time identifiers 106, where each time identifier (which is a cell in the row) identifies a time block of programming. Grid 102 also includes cells of program listings, such as program listing 108, where each listing provides the title of the program provided on the listing's associated channel and time. With a user input device, a user can select program listings by moving highlight region 110. Information relating to the program listing selected by highlight region 110 may be provided in program information region 112. Region 112 may include, for example, the program title, the program description, the time the program is provided (if applicable), the channel the program is on (if applicable), the program's rating, and other desired information.

In addition to providing access to linear programming (e.g., content that is scheduled to be transmitted to a plurality of user equipment devices at a predetermined time and is provided according to a schedule), the media guidance application also provides access to non-linear programming (e.g., content accessible to a user equipment device at any time and is not provided according to a schedule). Non-linear programming may include content from different content sources including on-demand content (e.g., VOD), Internet content (e.g., streaming media, downloadable media, etc.), locally stored content (e.g., content stored on any user equipment device described above or other storage device), or other time-independent content. On-demand content may include movies or any other content provided by a particular content provider (e.g., HBO On Demand providing “The Sopranos” and “Curb Your Enthusiasm”). HBO ON DEMAND is a service mark owned by Time Warner Company L. P. et al. and THE SOPRANOS and CURB YOUR ENTHUSIASM are trademarks owned by the Home Box Office, Inc. Internet content may include web events, such as a chat session or Webcast, or content available on-demand as streaming content or downloadable content through an Internet web site or other Internet access (e.g. FTP).

Grid 102 may provide media guidance data for non-linear programming including on-demand listing 114, recorded content listing 116, and Internet content listing 118. A display combining media guidance data for content from different types of content sources is sometimes referred to as a “mixed-media” display. Various permutations of the types of media guidance data that may be displayed that are different than display 100 may be based on user selection or guidance application definition (e.g., a display of only recorded and broadcast listings, only on-demand and broadcast listings, etc.). As illustrated, listings 114, 116, and 118 are shown as spanning the entire time block displayed in grid 102 to indicate that selection of these listings may provide access to a display dedicated to on-demand listings, recorded listings, or Internet listings, respectively. In some embodiments, listings for these content types may be included directly in grid 102. Additional media guidance data may be displayed in response to the user selecting one of the navigational icons 120. (Pressing an arrow key on a user input device may affect the display in a similar manner as selecting navigational icons 120.)

Display 100 may also include video region 122, advertisement 124, and options region 126. Video region 122 may allow the user to view and/or preview programs that are currently available, will be available, or were available to the user. The content of video region 122 may correspond to, or be independent from, one of the listings displayed in grid 102. Grid displays including a video region are sometimes referred to as picture-in-guide (PIG) displays. PIG displays and their functionalities are described in greater detail in Satterfield et al. U.S. Pat. No. 6,564,378, issued May 13, 2003 and Yuen et al. U.S. Pat. No. 6,239,794, issued May 29, 2001, which are hereby incorporated by reference herein in their entireties. PIG displays may be included in other media guidance application display screens of the embodiments described herein.

Advertisement 124 may provide an advertisement for content that, depending on a viewer's access rights (e.g., for subscription programming), is currently available for viewing, will be available for viewing in the future, or may never become available for viewing, and may correspond to or be unrelated to one or more of the content listings in grid 102. Advertisement 124 may also be for products or services related or unrelated to the content displayed in grid 102. Advertisement 124 may be selectable and provide further information about content, provide information about a product or a service, enable purchasing of content, a product, or a service, provide content relating to the advertisement, etc. Advertisement 124 may be targeted based on a user's profile/preferences, monitored user activity, the type of display provided, or on other suitable targeted advertisement bases.

While advertisement 124 is shown as rectangular or banner shaped, advertisements may be provided in any suitable size, shape, and location in a guidance application display. For example, advertisement 124 may be provided as a rectangular shape that is horizontally adjacent to grid 102. This is sometimes referred to as a panel advertisement. In addition, advertisements may be overlaid over content or a guidance application display or embedded within a display. Advertisements may also include text, images, rotating images, video clips, or other types of content described above. Advertisements may be stored in a user equipment device having a guidance application, in a database connected to the user equipment, in a remote location (including streaming media servers), or on other storage means, or a combination of these locations. Providing advertisements in a media guidance application is discussed in greater detail in, for example, Knudson et al., U.S. Patent Application Publication No. 2003/0110499, filed Jan. 17, 2003; Ward, III et al. U.S. Pat. No. 6,756,997, issued Jun. 29, 2004; and Schein et al. U.S. Pat. No. 6,388,714, issued May 14, 2002, which are hereby incorporated by reference herein in their entireties. It will be appreciated that advertisements may be included in other media guidance application display screens of the embodiments described herein.

Options region 126 may allow the user to access different types of content, media guidance application displays, and/or media guidance application features. Options region 126 may be part of display 100 (and other display screens described herein), or may be invoked by a user by selecting an on-screen option or pressing a dedicated or assignable button on a user input device. The selectable options within options region 126 may concern features related to program listings in grid 102 or may include options available from a main menu display. Features related to program listings may include searching for other air times or ways of receiving a program, recording a program, enabling series recording of a program, setting program and/or channel as a favorite, purchasing a program, or other features. Options available from a main menu display may include search options, VOD options, parental control options, Internet options, cloud-based options, device synchronization options, second screen device options, options to access various types of media guidance data displays, options to subscribe to a premium service, options to edit a user's profile, options to access a browse overlay, or other options.

The media guidance application may be personalized based on a user's preferences. A personalized media guidance application allows a user to customize displays and features to create a personalized “experience” with the media guidance application. This personalized experience may be created by allowing a user to input these customizations and/or by the media guidance application monitoring user activity to determine various user preferences. Users may access their personalized guidance application by logging in or otherwise identifying themselves to the guidance application. Customization of the media guidance application may be made in accordance with a user profile. The customizations may include varying presentation schemes (e.g., color scheme of displays, font size of text, etc.), aspects of content listings displayed (e.g., only HDTV or only 3D programming, user-specified broadcast channels based on favorite channel selections, re-ordering the display of channels, recommended content, etc.), desired recording features (e.g., recording or series recordings for particular users, recording quality, etc.), parental control settings, customized presentation of Internet content (e.g., presentation of social media content, e-mail, electronically delivered articles, etc.) and other desired customizations.

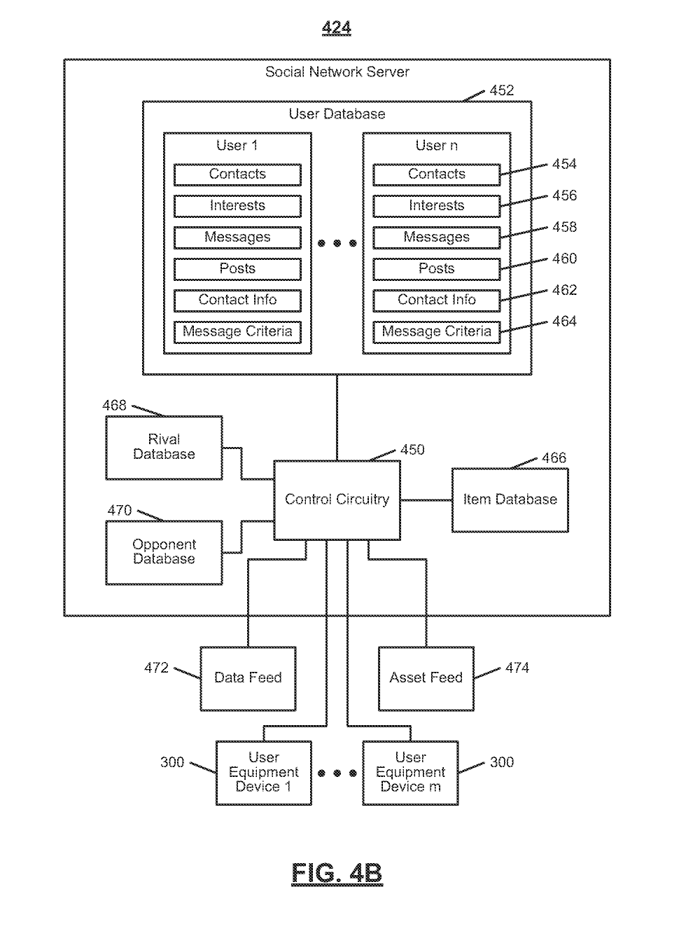

The media guidance application may allow a user to provide user profile information or may automatically compile user profile information. The media guidance application may, for example, monitor the content the user accesses and/or other interactions the user may have with the guidance application. Additionally, the media guidance application may obtain all or part of other user profiles that are related to a particular user (e.g., from other web sites on the Internet the user accesses, such as www.allrovi.com, from other media guidance applications the user accesses, from other interactive applications the user accesses, from another user equipment device of the user, from a social network profile associated with the user, etc.), and/or obtain information about the user from other sources that the media guidance application may access. As a result, a user can be provided with a unified guidance application experience across the user's different user equipment devices. This type of user experience is described in greater detail below in connection with FIG. 4A. Additional personalized media guidance application features are described in greater detail in Ellis et al., U.S. Patent Application Publication No. 2005/0251827, filed Jul. 11, 2005, Boyer et al., U.S. Pat. No. 7,165,098, issued January 16, 2007, and Ellis et al., U.S. Patent Application Publication No. 2002/0174430, filed Feb. 21, 2002, which are hereby incorporated by reference herein in their entireties.

Another display arrangement for providing media guidance is shown in FIG. 2. Video mosaic display 200 includes selectable options 202 for content information organized based on content type, genre, and/or other organization criteria. In display 200, television listings option 204 is selected, thus providing listings 206, 208, 210, and 212 as broadcast program listings. In display 200 the listings may provide graphical images including cover art, still images from the content, video clip previews, live video from the content, or other types of content that indicate to a user the content being described by the media guidance data in the listing. Each of the graphical listings may also be accompanied by text to provide further information about the content associated with the listing. For example, listing 208 may include more than one portion, including media portion 214 and text portion 216. Media portion 214 and/or text portion 216 may be selectable to view content in full-screen or to view information related to the content displayed in media portion 214 (e.g., to view listings for the channel that the video is displayed on).

The listings in display 200 are of different sizes (i.e., listing 206 is larger than listings 208, 210, and 212), but if desired, all the listings may be the same size. Listings may be of different sizes or graphically accentuated to indicate degrees of interest to the user or to emphasize certain content, as desired by the content provider or based on user preferences. Various systems and methods for graphically accentuating content listings are discussed in, for example, Yates, U.S. Patent Application Publication No. 2010/0153885, filed Dec. 29, 2005, which is hereby incorporated by reference herein in its entirety.

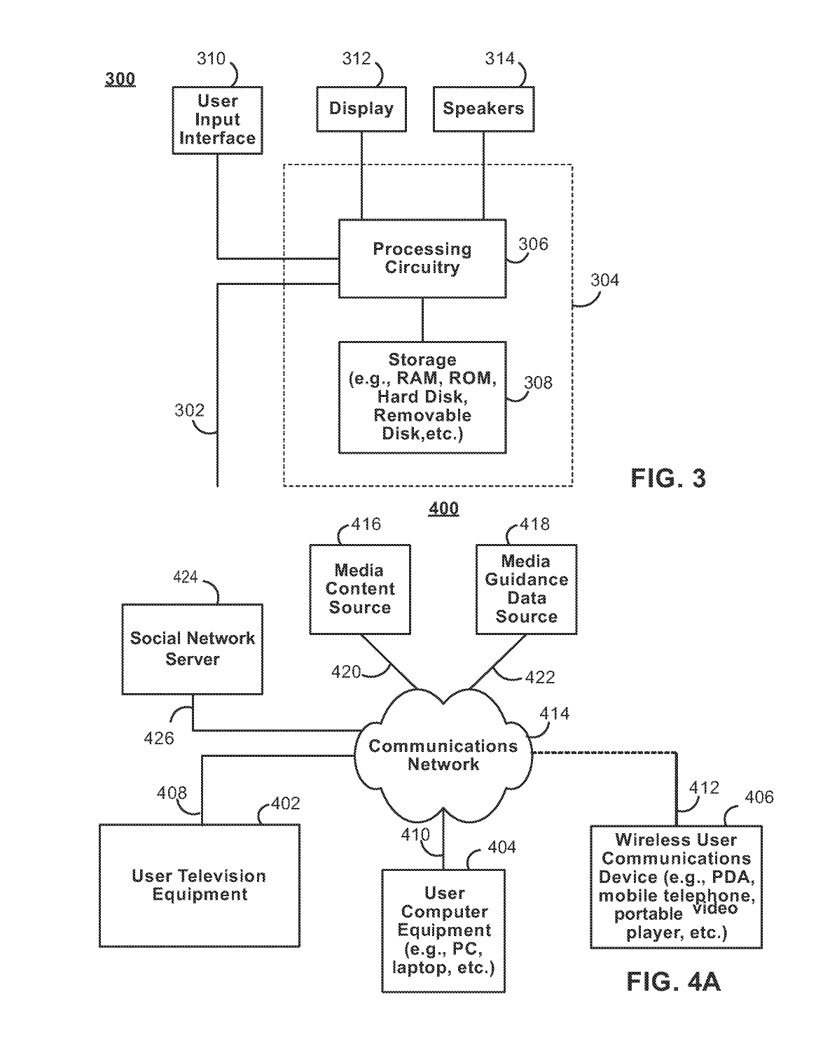

Users may access content and the media guidance application (and its display screens described above and below) from one or more of their user equipment devices. FIG. 3 shows a generalized embodiment of illustrative user equipment device 300. More specific implementations of user equipment devices are discussed below in connection with FIG. 4A. User equipment device 300 may receive content and data via input/output (hereinafter “I/O”) path 302. I/O path 302 may provide content (e.g., broadcast programming, on-demand programming, Internet content, content available over a local area network (LAN) or wide area network (WAN), and/or other content) and data to control circuitry 304, which includes processing circuitry 306 and storage 308. Control circuitry 304 may be used to send and receive commands, requests, and other suitable data using I/O path 302. I/O path 302 may connect control circuitry 304 (and specifically processing circuitry 306) to one or more communications paths (described below). I/O functions may be provided by one or more of these communications paths, but are shown as a single path in FIG. 3 to avoid overcomplicating the drawing.

Control circuitry 304 may be based on any suitable processing circuitry such as processing circuitry 306. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 304 executes instructions for a media guidance application stored in memory (i.e., storage 308). Specifically, control circuitry 304 may be instructed by the media guidance application to perform the functions discussed above and below. For example, the media guidance application may provide instructions to control circuitry 304 to generate the media guidance displays. In some implementations, any action performed by control circuitry 304 may be based on instructions received from the media guidance application.

In client-server based embodiments, control circuitry 304 may include communications circuitry suitable for communicating with a guidance application server or other networks or servers. The instructions for carrying out the above mentioned functionality may be stored on the guidance application server. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communications networks or paths (which is described in more detail in connection with FIG. 4A). In addition, communications circuitry may include circuitry that enables peer-to-peer communication of user equipment devices, or communication of user equipment devices in locations remote from each other (described in more detail below).

Memory may be an electronic storage device provided as storage 308 that is part of control circuitry 304. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 308 may be used to store various types of content described herein as well as media guidance information, described above, and guidance application data, described above. Nonvolatile memory may also be used (e.g., to launch a boot-up routine and other instructions). Cloud-based storage, described in relation to FIG. 4A, may be used to supplement storage 308 or instead of storage 308.

Control circuitry 304 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 304 may also include scaler circuitry for upconverting and downconverting content into the preferred output format of the user equipment 300. Circuitry 304 may also include digital-to-analog converter circuitry and analog-to-digital converter circuitry for converting between digital and analog signals. The tuning and encoding circuitry may be used by the user equipment device to receive and to display, to play, or to record content. The tuning and encoding circuitry may also be used to receive guidance data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 308 is provided as a separate device from user equipment 300, the tuning and encoding circuitry (including multiple tuners) may be associated with storage 308.

A user may send instructions to control circuitry 304 using user input interface 310. User input interface 310 may be any suitable user interface, such as a remote control, mouse, trackball, keypad, keyboard, touch screen, touchpad, stylus input, joystick, voice recognition interface, or other user input interfaces. Display 312 may be provided as a stand-alone device or integrated with other elements of user equipment device 300. Display 312 may be one or more of a monitor, a television, a liquid crystal display (LCD) for a mobile device, or any other suitable equipment for displaying visual images. In some embodiments, display 312 may be HDTV-capable. In some embodiments, display 312 may be a 3D display, and the interactive media guidance application and any suitable content may be displayed in 3D. A video card or graphics card may generate the output to the display 312. The video card may offer various functions such as accelerated rendering of 3D scenes and 2D graphics, MPEG-2/MPEG-4 decoding, TV output, or the ability to connect multiple monitors. The video card may be any processing circuitry described above in relation to control circuitry 304. The video card may be integrated with the control circuitry 304. Speakers 314 may be provided as integrated with other elements of user equipment device 300 or may be stand-alone units. The audio component of videos and other content displayed on display 312 may be played through speakers 314. In some embodiments, the audio may be distributed to a receiver (not shown), which processes and outputs the audio via speakers 314.

The guidance application may be implemented using any suitable architecture. For example, it may be a stand-alone application wholly implemented on user equipment device 300. In such an approach, instructions of the application are stored locally, and data for use by the application is downloaded on a periodic basis (e.g., from an out-of-band feed, from an Internet resource, or using another suitable approach). In some embodiments, the media guidance application is a client-server based application. Data for use by a thick or thin client implemented on user equipment device 300 is retrieved on-demand by issuing requests to a server remote to the user equipment device 300. In one example of a client-server based guidance application, control circuitry 304 runs a web browser that interprets web pages provided by a remote server.

In some embodiments, the media guidance application is downloaded and interpreted or otherwise run by an interpreter or virtual machine (run by control circuitry 304). In some embodiments, the guidance application may be encoded in the ETV Binary Interchange Format (EBIF), received by control circuitry 304 as part of a suitable feed, and interpreted by a user agent running on control circuitry 304. For example, the guidance application may be an EBIF application. In some embodiments, the guidance application may be defined by a series of JAVA-based files that are received and run by a local virtual machine or other suitable middleware executed by control circuitry 304. In some of such embodiments (e.g., those employing MPEG-2 or other digital media encoding schemes), the guidance application may be, for example, encoded and transmitted in an MPEG-2 object carousel with the MPEG audio and video packets of a program.

User equipment device 300 of FIG. 3 can be implemented in system 400 of FIG. 4A as user television equipment 402, user computer equipment 404, wireless user communications device 406, or any other type of user equipment suitable for accessing content, such as a non-portable gaming machine. For simplicity, these devices may be referred to herein collectively as user equipment or user equipment devices, and may be substantially similar to user equipment devices described above. User equipment devices, on which a media guidance application may be implemented, may function as a standalone device or may be part of a network of devices. Various network configurations of devices may be implemented and are discussed in more detail below.

A user equipment device utilizing at least some of the system features described above in connection with FIG. 3 may not be classified solely as user television equipment 402, user computer equipment 404, or a wireless user communications device 406. For example, user television equipment 402 may, like some user computer equipment 404, be Internet-enabled allowing for access to Internet content, while user computer equipment 404 may, like some television equipment 402, include a tuner allowing for access to television programming. The media guidance application may have the same layout on various different types of user equipment or may be tailored to the display capabilities of the user equipment. For example, on user computer equipment 404, the guidance application may be provided as a web site accessed by a web browser. In another example, the guidance application may be scaled down for wireless user communications devices 406.

In system 400, there is typically more than one of each type of user equipment device but only one of each is shown in FIG. 4A to avoid overcomplicating the drawing. In addition, each user may utilize more than one type of user equipment device and also more than one of each type of user equipment device.

In some embodiments, a user equipment device (e.g., user television equipment 402, user computer equipment 404, wireless user communications device 406) may be referred to as a “second screen device.” For example, a second screen device may supplement content presented on a first user equipment device. The content presented on the second screen device may be any suitable content that supplements the content presented on the first device. In some embodiments, the second screen device provides an interface for adjusting settings and display preferences of the first device. In some embodiments, the second screen device is configured for interacting with other second screen devices or for interacting with a social network. The second screen device can be located in the same room as the first device, a different room from the first device but in the same house or building, or in a different building from the first device.

The user may also set various settings to maintain consistent media guidance application settings across in-home devices and remote devices. Settings include those described herein, as well as channel and program favorites, programming preferences that the guidance application utilizes to make programming recommendations, display preferences, and other desirable guidance settings. For example, if a user sets a channel as a favorite on, for example, the web site www.allrovi.com on their personal computer at their office, the same channel would appear as a favorite on the user's in-home devices (e.g., user television equipment and user computer equipment) as well as the user's mobile devices, if desired. Therefore, changes made on one user equipment device can change the guidance experience on another user equipment device, regardless of whether they are the same or a different type of user equipment device. In addition, the changes made may be based on settings input by a user, as well as user activity monitored by the guidance application.

The user equipment devices may be coupled to communications network 414. Namely, user television equipment 402, user computer equipment 404, and wireless user communications device 406 are coupled to communications network 414 via communications paths 408, 410, and 412, respectively. Communications network 414 may be one or more networks including the Internet, a mobile phone network, mobile voice or data network (e.g., a 4G or LTE network), cable network, public switched telephone network, or other types of communications network or combinations of communications networks. Paths 408, 410, and 412 may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. Path 412 is drawn with dotted lines to indicate that in the exemplary embodiment shown in FIG. 4A it is a wireless path and paths 408 and 410 are drawn as solid lines to indicate they are wired paths (although these paths may be wireless paths, if desired). Communications with the user equipment devices may be provided by one or more of these communications paths, but are shown as a single path in FIG. 4A to avoid overcomplicating the drawing.

Although communications paths are not drawn between user equipment devices, these devices may communicate directly with each other via communication paths, such as those described above in connection with paths 408, 410, and 412, as well as other short-range point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a certification mark owned by Bluetooth SIG, INC. The user equipment devices may also communicate with each other directly through an indirect path via communications network 414.

System 400 includes content source 416, media guidance data source 418, and social network server 424 coupled to communications network 414 via communication paths 420, 422, and 426, respectively. Paths 420, 422, and 426 may include any of the communication paths described above in connection with paths 408, 410, and 412. Communications with the content source 416, media guidance data source 418, and social network server 424 may be exchanged over one or more communications paths, but are shown as a single path in FIG. 4A to avoid overcomplicating the drawing. In addition, there may be more than one of each of content source 416, media guidance data source 418, and social network server 424, but only one of each is shown in FIG. 4A to avoid overcomplicating the drawing. (The different types of each of these sources are discussed below.) If desired, content source 416, media guidance data source 418, and/or social network server 424 may be integrated as one source device. Although communications between sources 416 and 418 and server 424 with user equipment devices 402, 404, and 406 are shown as through communications network 414, in some embodiments, sources 416 and 418 and server 424 may communicate directly with user equipment devices 402, 404, and 406 via communication paths (not shown) such as those described above in connection with paths 408, 410, and 412.

Social network server 424 may store data related to the users of the social network. In addition, social network server 424 may store any information or content entered or uploaded by users of the social network. Social network server 424 may be in communication with one or more databases or data stores (not shown) for storing social network data or content. Social network server 424 may also perform processing functions for the social network, such as generating and transmitting automated messages described below, and may store instructions for performing these or other functions. An exemplary social network server is described in further detail in relation to FIG. 4B. In some embodiments, a social network may be implemented as a cloud-based service, as discussed below.

Content source 416 may include one or more types of content distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other content providers. NBC is a trademark owned by the National Broadcasting Company, Inc., ABC is a trademark owned by the American Broadcasting Company, Inc., and HBO is a trademark owned by the Home Box Office, Inc. Content source 416 may be the originator of content (e.g., a television broadcaster, a Webcast provider, etc.) or may not be the originator of content (e.g., an on-demand content provider, an Internet provider of content of broadcast programs for downloading, etc.). Content source 416 may include cable sources, satellite providers, on-demand providers, Internet providers, over-the-top content providers, or other providers of content. Content source 416 may also include a remote media server used to store different types of content (including video content selected by a user), in a location remote from any of the user equipment devices. Systems and methods for remote storage of content, and providing remotely stored content to user equipment are discussed in greater detail in connection with Ellis et al., U.S. Pat. No. 7,761,892, issued Jul. 20, 2010, which is hereby incorporated by reference herein in its entirety.

Media guidance data source 418 may provide media guidance data, such as the media guidance data described above. Media guidance application data may be provided to the user equipment devices using any suitable approach. In some embodiments, the guidance application may be a stand-alone interactive television program guide that receives program guide data via a data feed (e.g., a continuous feed or trickle feed). Program schedule data and other guidance data may be provided to the user equipment on a television channel sideband, using an in-band digital signal, using an out-of-band digital signal, or by any other suitable data transmission technique. Program schedule data and other media guidance data may be provided to user equipment on multiple analog or digital television channels.

In some embodiments, guidance data from media guidance data source 418 may be provided to users' equipment using a client-server approach. For example, a user equipment device may pull media guidance data from a server, or a server may push media guidance data to a user equipment device. In some embodiments, a guidance application client residing on the user's equipment may initiate sessions with source 418 to obtain guidance data when needed, e.g., when the guidance data is out of date or when the user equipment device receives a request from the user to receive data. Media guidance may be provided to the user equipment with any suitable frequency (e.g., continuously, daily, a user-specified period of time, a system-specified period of time, in response to a request from user equipment, etc.). Media guidance data source 418 may provide user equipment devices 402, 404, and 406 the media guidance application itself or software updates for the media guidance application.

Media guidance applications may be, for example, stand-alone applications implemented on user equipment devices. For example, the media guidance application may be implemented as software or a set of executable instructions which may be stored in storage 308, and executed by control circuitry 304 of a user equipment device 300. In some embodiments, media guidance applications may be client-server applications where only a client application resides on the user equipment device, and server application resides on a remote server. For example, media guidance applications may be implemented partially as a client application on control circuitry 304 of user equipment device 300 and partially on a remote server as a server application (e.g., media guidance data source 418) running on control circuitry of the remote server. When executed by control circuitry of the remote server (such as media guidance data source 418), the media guidance application may instruct the control circuitry to generate the guidance application displays and transmit the generated displays to the user equipment devices. The server application may instruct the control circuitry of the media guidance data source 418 to transmit data for storage on the user equipment. The client application may instruct control circuitry of the receiving user equipment to generate the guidance application displays.

Content and/or media guidance data delivered to user equipment devices 402, 404, and 406 may be over-the-top (OTT) content. OTT content delivery allows Internet-enabled user devices, including any user equipment device described above, to receive content that is transferred over the Internet, including any content described above, in addition to content received over cable or satellite connections. OTT content is delivered via an Internet connection provided by an Internet service provider (ISP), but a third party distributes the content. The ISP may not be responsible for the viewing abilities, copyrights, or redistribution of the content, and may only transfer IP packets provided by the OTT content provider. Examples of OTT content providers include YOUTUBE, NETFLIX, and HULU, which provide audio and video via IP packets. Youtube is a trademark owned by Google Inc., Netflix is a trademark owned by Netflix Inc., and Hulu is a trademark owned by Hulu, LLC. OTT content providers may additionally or alternatively provide media guidance data described above. In addition to content and/or media guidance data, providers of OTT content can distribute media guidance applications (e.g., web-based applications or cloud-based applications), or the content can be displayed by media guidance applications stored on the user equipment device.

Media guidance system 400 is intended to illustrate a number of approaches, or network configurations, by which user equipment devices and sources of content and guidance data may communicate with each other for the purpose of accessing content and providing media guidance. The embodiments described herein may be applied in any one or a subset of these approaches, or in a system employing other approaches for delivering content and providing media guidance. The following four approaches provide specific illustrations of the generalized example of FIG. 4A.

In one approach, user equipment devices may communicate with each other within a home network. User equipment devices can communicate with each other directly via short-range point-to-point communication schemes described above, via indirect paths through a hub or other similar device provided on a home network, or via communications network 414. Each of the multiple individuals in a single home may operate different user equipment devices on the home network. As a result, it may be desirable for various media guidance information or settings to be communicated between the different user equipment devices. For example, it may be desirable for users to maintain consistent media guidance application settings on different user equipment devices within a home network, as described in greater detail in Ellis et al., U.S. patent application Ser. No. 11/179,410, filed Jul. 11, 2005. Different types of user equipment devices in a home network may also communicate with each other to transmit content. For example, a user may transmit content from user computer equipment to a portable video player or portable music player.

In a second approach, users may have multiple types of user equipment by which they access content and obtain media guidance. For example, some users may have home networks that are accessed by in-home and mobile devices. Users may control in-home devices via a media guidance application implemented on a remote device. For example, users may access an online media guidance application on a website via a personal computer at their office, or a mobile device such as a PDA or web-enabled mobile telephone. The user may set various settings (e.g., recordings, reminders, or other settings) on the online guidance application to control the user's in-home equipment. The online guide may control the user's equipment directly, or by communicating with a media guidance application on the user's in-home equipment. Various systems and methods for user equipment devices communicating, where the user equipment devices are in locations remote from each other, is discussed in, for example, Ellis et al., U.S. Pat. No. 8,046,801, issued Oct. 25, 2011, which is hereby incorporated by reference herein in its entirety.

In a third approach, users of user equipment devices inside and outside a home can use their media guidance application to communicate directly with content source 416 to access content. Specifically, within a home, users of user television equipment 402 and user computer equipment 404 may access the media guidance application to navigate among and locate desirable content. Users may also access the media guidance application outside of the home using wireless user communications devices 406 to navigate among and locate desirable content.

In a fourth approach, user equipment devices may operate in a cloud computing environment to access cloud services. In a cloud computing environment, various types of computing services for content sharing, storage or distribution (e.g., video sharing sites or social networking sites) are provided by a collection of network-accessible computing and storage resources, referred to as “the cloud.” For example, the cloud can include a collection of server computing devices, which may be located centrally or at distributed locations, that provide cloud-based services to various types of users and devices connected via a network such as the Internet via communications network 414. These cloud resources may include one or more content sources 416 and one or more media guidance data sources 418. In addition or in the alternative, the remote computing sites may include other user equipment devices, such as user television equipment 402, user computer equipment 404, and wireless user communications device 406. For example, the other user equipment devices may provide access to a stored copy of a video or a streamed video. In such embodiments, user equipment devices may operate in a peer-to-peer manner without communicating with a central server.

The cloud provides access to services, such as content storage, content sharing, or social networking services, among other examples, as well as access to any content described above, for user equipment devices. Services can be provided in the cloud through cloud computing service providers, or through other providers of online services. For example, the cloud-based services can include a content storage service, a content sharing site, a social networking site, or other services via which user-sourced content is distributed for viewing by others on connected devices. These cloud-based services may allow a user equipment device to store content to the cloud and to receive content from the cloud rather than storing content locally and accessing locally-stored content.

A user may use various content capture devices, such as camcorders, digital cameras with video mode, audio recorders, mobile phones, and handheld computing devices, to record content. The user can upload content to a content storage service on the cloud either directly, for example, from user computer equipment 404 or wireless user communications device 406 having content capture feature. Alternatively, the user can first transfer the content to a user equipment device, such as user computer equipment 404. The user equipment device storing the content uploads the content to the cloud using a data transmission service on communications network 414. In some embodiments, the user equipment device itself is a cloud resource, and other user equipment devices can access the content directly from the user equipment device on which the user stored the content.

Cloud resources may be accessed by a user equipment device using, for example, a web browser, a media guidance application, a desktop application, a mobile application, and/or any combination of access applications of the same. The user equipment device may be a cloud client that relies on cloud computing for application delivery, or the user equipment device may have some functionality without access to cloud resources. For example, some applications running on the user equipment device may be cloud applications, i.e., applications delivered as a service over the Internet, while other applications may be stored and run on the user equipment device. In some embodiments, a user device may receive content from multiple cloud resources simultaneously. For example, a user device can stream audio from one cloud resource while downloading content from a second cloud resource. Or a user device can download content from multiple cloud resources for more efficient downloading. In some embodiments, user equipment devices can use cloud resources for processing operations such as the processing operations performed by processing circuitry described in relation to FIG. 3.

With the growing popularity of social networks, such as Facebook™, MySpace™, and Twitter™, users have limitless potential to share ideas, activities, events, and interests. A social network service essentially consists of a representation of each user (e.g., a user profile), his social links, and a variety of additional services. A user may communicate with the social network through user equipment device 300, described above in relation to FIG. 3.

The user may communicate with the social network via a website accessed by a web browser running on user equipment device 300. Alternatively, the user may communicate with the social network via a widget on user equipment device 300. Widgets are software programs that provide information from the Internet to a user through web services. The widget may be an application that is downloaded or installed on user equipment device 300, and the widget may be run by an interpreter or virtual machine run by control circuitry 304 of user equipment device 300. The widget may allow the user to interact with web services while viewing social media content on user equipment device 300. The widget may have the same layout on the various types of user equipment devices, or the layout may be tailored to the display capabilities of each user equipment device.

User equipment devices 300, such as user television equipment 402, user computer equipment 404, and wireless user communications devices 406, send data to and receive data from the social network via communications network 414. The social network may include of one or more social network server 424, shown in detail in FIG. 4B. For convenience, a single social network server 424 will be described as performing the social network storage and processing functions described herein. However, in some other embodiments, the functions described herein can be performed by a plurality of servers (including servers that are not dedicated to the social network). Each server may perform a subset of the storage and/or processing functions of social network server 424. In some embodiments, the social network may be implemented as a cloud-based service, as discussed above. In other embodiments, the functions of social network server 424 may be performed by one or more user equipment devices 300, one or more media content sources 416, or any combination of servers, user equipment devices, media content sources, and/or other computing devices that are in communication via one or more communications networks 414.

Social network server 424 may include control circuitry 450 for performing data receiving, transmitting, and processing functions described herein. Control circuitry 450 may be similar to control circuitry 304, described above. Social network server 424 may also include user database 452 for storing data associated with social network users, such as contacts 454, interests 456, messages 458, posts 460, contact information 462, and message criteria 464. Social network server 424 may automatically generate and transmit messages to users based on information stored in user database 450 along with data stored in item database 466, rival database 468, and/or opponent database 470. Social network server 424 may receive data from which to generate automated messages from data feed 472 and/or asset feed 474. These feeds 472 and 474 and the various elements of social network server 424 are described in further detail herein.

Social network server 424 may store data related to each social network user in user database 452. Users of a social network may include individuals or other entities, such as sports teams, performing artists, bands, television programs, magazines, books, companies, products, brands, charities, institutions, etc. Users may maintain connections to other individual users and/or entities in the social network. As referred to herein, the term “contact” should be understood to mean a relationship between two or more users of the social network. Contact data 454 that identifies each user's contacts may be stored in user database 452. A contact may be created when a user designates another user as a friend, follower, subscriber, buddy, etc. A contact may be created when a user designates another user as being in a circle or group, or when a user designates himself as being in a circle or group. A contact may be created by a designation or other action by a single user, or it may require action by two or more users. A contact may be created using any other means of associating two or more users on a social network.

In some embodiments, a user can create a contact by indicating that he has an interest in or “likes” another user. In some embodiments, items that a user is interested in may be stored separately from a user's contacts, which may be considered to include friends, family, and acquaintances of the user, and may further include any individual user of the social network. In such embodiments where contacts are separate from other items of interest, interest data 456 identifying users' items of interest or “liked” items may be stored in user database 452. Information related to items that the social network may not consider users may be stored in item database 466. These items may include, for example, entities such as sports teams, performing artists, bands, television programs, magazines, books, companies, products, brands, charities, institutions, etc.

A user of a social network may post social network content to his user profile or another user's user profile, or a user may send and receive social network content to an from other users through the social network as, for example, messages. As referred to herein, the term “social network content” should be understood to mean any electronically viewable content, such as text, links to websites, video clips, audio, pictures, television programming, pay-per-view programming, on-demand programs (as in video-on-demand (VOD) systems), Internet content (e.g., streaming content, downloadable content, Webcasts, etc.), content information, rotating images, documents, playlists, websites, articles, books, electronic books, blog entries, advertisements, chat sessions, applications, games, reactions to social network content (e.g., likes, dislikes, comments, shares, ratings, etc.) and/or any other media or multimedia and/or combination of the same.

Social network content sent by a user or received by the user from another user may be stored as messages 458 in user database 452. Social network content posted by a user or posted to the user's profile by another user may be stored as posts 460 in user database 452. In some embodiments, messages 458 and/or posts 460 may contain links to social network content or instructions or locations for accessing the social network content, rather than the content itself. For example, content available via the social network may be stored on media content source 416 and accessed by the user equipment devices 300 directly from media content source 416 or via social network server 424.

A user of a social network may post social network content to, for example, his user profile, another user profile, a group profile, or any other page on a social network. The post may be visible to all users of the social network or who can access the social network. Alternatively, the post may visible to only one user or a select group of users. For example, a user may post social network content so that is visible to a specified set or circle of contacts, all of his contacts, second-order contacts (i.e., contacts of his contacts), or nth-order contacts. If a user posts content to a contact's profile or a group profile, the content visibility may be based upon visibility settings of the contact or group. For example, if a user posts content to a contact's profile, the content may be visible to all of the contact's contacts, even if some of these second order contacts are not the user's contacts. If a user posts content to a group, the content may be visible to all member of the group. The visibility of the post may be stored as post data 460.

A user may generate social network content by, e.g., entering text, uploading a file, interacting with the social network, interacting with an application within the social network, interacting with an application or web page outside the social network, or adding a link. The social network can thus receive social network content by, e.g., receiving entered text, receiving an uploaded file, receiving user commands, receiving data from applications within or outside the social network, receiving data from web sites, or receiving links. In addition to social network content input by users, social network content may include content from cable sources, satellite content providers, on-demand content providers, Internet content providers, local or remote media servers, or other providers of media content. A social network content source may provide media such as audio and video clips, program episodes, advertisements, blooper reels, cast interviews, promotional trailers, and online links to any of the above types of media. Social network content is received by control circuitry 450, which stores the received social network content with any additional data for describing the social network content, such as its sender, recipient, visibility, time received, etc. in user database 452.

Social network content can be promulgated across the network by its users. When a first user adds social network content to the social network, the social network content may be visible to one or more users of the social network. After a first user has made social network content available to a certain set of social network users (e.g., the first user's contacts), a second user to whom the social network content is visible can make the social network content available to a different set of social network users (e.g., the second user's contacts). The second user can make the social network content available by, for example, reposting the social network content, sending a message containing the social network content, posting a link to the content, reacting the social network content (e.g., liking, disliking, rating, or commenting on the content), or interacting with the social network content in some other way.

In some embodiments, such as embodiments in which social network content is promulgated in the manner described above, it may be more efficient to store messages, posts and/or data related to the messages or posts in a database that is separate from or linked to the user database 452, rather than storing messages 458 and posts 460 as user data in user database 452. In this case, social network server 424 may contain an additional social network content database (not shown). In these embodiments, message data 458 and/or post data 460 may point to content in the social network content database rather than store the content. Message data 458 and post data 460 may still include senders, recipients, visibility, time received, etc. Alternatively, social network content database may contain all message and post information, and message data 458 and post data 460 may not be included in user database 452. The social network content database may be internal or external to social network server 424, and may be distributed across multiple devices. Any other arrangement for storing social network content not described herein may be used.

In some embodiments, social network server 424 or another social network content source, such as media content source 416 or one or more user equipment devices 300, may automatically identify and/or provide social network content or content recommendations to a user based on the user's activities on the social network, or a user of the social network may provide social network content recommendations to one or more other users, as described in greater detail in Ketkar, U.S. Patent Application Publication No. 2012/0030587, filed Jul. 30, 2010, which is incorporated herein by reference.

In some embodiments, a social network may provide an automated messaging feature for automatically sending social network content from one user of the social network to another user of the social network. As discussed herein, a server may receive a user selection identifying a competitor involved in a competition from a user of a social network. The server may automatically identify a media asset associated with the competitor identified by the user selection. The server may receive or access data identifying the competitor's opponent(s) in the competition. Using data stored on the social network, the server may identify a contact of the user in the social network with an interest in the competition (e.g., an interest in the competitor, an opponent, or the competition itself). The server may automatically transmit the identified media asset to the identified contact. These functions are described herein as being performed by a server of a social network.

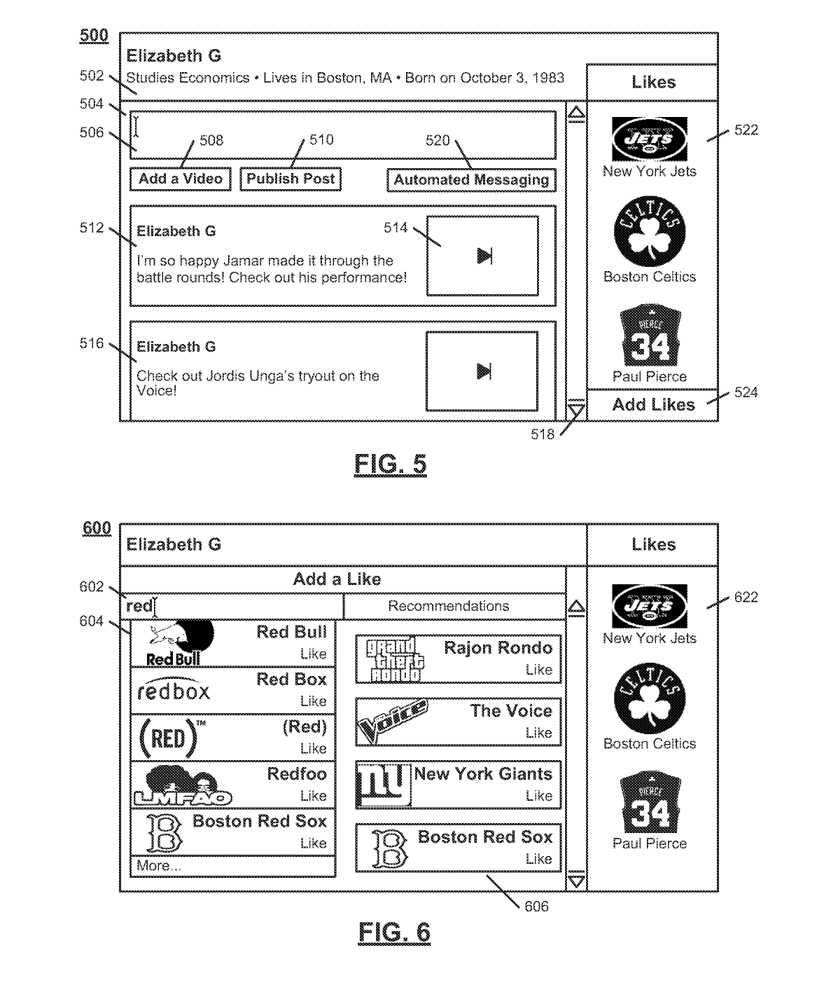

The process of setting up automated messaging and receiving automated messages is illustrated by the display screens shown in FIGS. 5 through 16. An application on user equipment device 300 or a remote application, such as an application running on social network server 424, may instruct control circuitry 304 to display, using display 312, display screens such as those depicted in FIGS. 5 through 16. The application may contain instructions for receiving user input, displaying output, and performing other functions described herein.

FIG. 5 is an illustrative display screen 500 showing a user profile in a social network. As referred to herein, the term “user profile” should be understood to mean a display of information related to the user, such as the user's name, residence, gender, birthday, other biographical information, contacts, interests, status, links, photos, videos, and any other social network content specified by the user. The user profile may further include posts of social network content from the user's contacts or other social network users. As described above, any of this information may be stored in user database 452.

Social network server 424 and/or control circuitry 304 may tailor the appearance of a user profile based on the identify of the user accessing the user profile or the type of user equipment device accessing the user profile. For example, contacts of a user may be shown more profile information than users who are not contacts with that user, and a user may identify specific contacts that should be shown a restricted profile with less information than is visible to other contacts. Further, a user profile viewed on a mobile device may contain less information than a user profile viewed on a device with a larger screen size, such as a laptop computer.

User profile display screen 500 may be displayed on user equipment device 300 by display 312. User profile display screen 500 includes the user's biographical information 502, such as the user's name, occupation, residence, and birthday. This information may be requested by control circuitry 304 and transmitted to control circuitry 304 by social network server 424. Below the biographical information 502 is a post region 504 in which the user and/or other users of the social network can post social network content. Scroll bar 518 next to post region 504 allows a user to scroll to see additional posts in post region 504. To write a post, a user types a message into text entry box 506 using user input interface 310. The message is received by the processing circuitry 306 and may be temporarily stored to storage 308 or sent to and stored by social network server 424 as it is being entered.

To add a video to the post, the user selects the Add Video button 508. Upon receiving a selection of the Add Video button 508, control circuitry 304 may display an upload menu with which a user can specify a path to a file containing the video he wishes to upload or a link to a website containing the video he wishes to upload. Upon receiving a path to a location on user equipment device 300, control circuitry 304 accesses the specified video and uploads it to the social network server 424. Upon receiving a link to a website containing the video, control circuitry 304 may access the website and download the video, or control circuitry 304 may send the link to social network server 424 to access the video. A video may be added to the post by an alternative upload mechanism, e.g., by dragging and dropping a video into the text entry box 506. The user profile display screen 500 may include functionality with which the user can add other any social media content through similar means.

The user profile display screen 500 also includes Automated Messaging button 520. Upon receiving a selection of the Automated Messaging button 520, control circuitry 304 displays Set Up Automated Messaging screen 700, shown in FIG. 7, for receiving user input for setting up automated messaging to a contact related to an interest of the user or the contact. Automated messaging is described in greater detail in relation to FIGS. 7 through 19.

Once the user has finished entering the post, he selects the Publish Post button 510. Upon receiving a selection of the Publish Post button 510, control circuitry 304 sends the text entered into the text entry box 506, the video or links to the video, and/or any other social network content specified by the user to social media server 424. The social media server 424 then converts the received data into a post 460, which, when requested by user equipment device 300, may be transmitted by social network server 424 to user equipment device 300 and displayed by user equipment device 300 in the manner of posts 512 and 516. Posts 512 and 516 each include the identity of the poster (in this case, the user identified by user profile display screen 500), the text entered by the user, and video 514 added by the user. The posts 512 and 516 indicate the user's interest in the television show The Voice, which is a singing competition.

The user profile display screen 500 further includes Like region 522, which includes items representing the user's interests. In some embodiments, some or all of the items in Like region 522 are considered contacts. The items in the Like region may be links to profiles or other pages; when control circuitry 304 receives a user selection of an item in Like region 522, control circuitry 304 may retrieve data related to the like from social network server 424 and display a screen that provides information related to the selected item. Like region 522 indicates that the user likes the football team New York Jets, the basketball team the Boston Celtics, and Paul Pierce, a basketball player who plays for the Boston Celtics. Below Like region 522 is Add Likes button 524, which a user can select to indicate more items in which he is interested.

When control circuitry 304 receives a selection of Add Likes button 524, control circuitry 304 may retrieve data for displaying an Add a Like screen 600 from social network server 424 and display the Add a Like screen 600, shown in FIG. 6, which displays items that the user can select to indicate his interests. Add a Like screen 600 may include text entry box 602, in which a user enters a word or phrase. Control circuitry 306 receives the text entered by the user and sends it to social networking server 424. Control circuitry 450 may determine suggestions of items that the user may be searching for by comparing the text entered by the user to the names of users in user database 452 and/or items in item database 466. Control circuitry 450 transmits text and images for displaying these items to control circuitry 304. Control circuitry 304 displays the text and images as selectable item suggestions 604 that, when selected by a user, are added to a list of the user's likes stored by social network server 424 as contacts 454 or interests 456. The newly liked item, along with the user's other liked items, may be displayed by control circuitry 304 in Like region 622.

For example, in FIG. 6, the user has typed the string “red”. Upon receiving the string, control circuitry 450 may identify the most likely items that the user is trying to enter and transmit them to control circuitry 304 for display as suggested items 604. For example, control circuitry 450 may find the most popular items that begin with “red” or contain the string “red”, or may perform further analysis, such as correcting spelling errors or determining the most likely items conditioned on other information of the user's profile (e.g., other items the user likes). Suggested items 604 may be confined to certain categories, e.g., products, services, bands, artists, sports teams, sports groups, etc., as specified by the user.

Social network server 424 may also provide recommendations based on the user's likes and/or other user profile data. Social network server 424 transmits data for displaying the recommendations to control circuitry 306, which causes display 312 to display selectable Recommendations 606. When a user selects a Recommendation 606, control circuitry 304 receives the user selection and sends data identifying the selected item to social network server 424. Control circuitry 450 adds the item to the user's likes as contacts 454 or interests 456 and sends data to control circuitry 304 for displaying in Like region 622.

To generate Recommendations 606, control circuitry 450 may identify items related to the user's liked items. Control circuitry 450 may compare properties of users stored in user database 452 and/or items stored in item database 466 to determine similarities between users and/or items, and thus identify users and/or items that are related to each other. For example, as shown in FIG. 6, control circuitry 450 determined that because the user is interested in the team the Boston Celtics and Paul Pierce, a player who plays for the Boston Celtics, the user has demonstrated an interest in the Boston Celtics and their players, so the user may also be interested in Rajon Rondo, another player for the Boston Celtics. The user may be interested in the team the Boston Red Sox because the user has demonstrated an interest in sports teams from Boston. The user may be interested in the team the New York Giants because his interest in the football team New York Jets demonstrates an interest in football teams from New York City.

Control circuitry 450 may look beyond the items the user has liked to generate Recommendations 606. For example, control circuitry 450 may perform data analytics on any other social network content stored in user database 452 or otherwise associated with the user. In FIG. 5, the user's posts 512 and 516 indicate the user's interest in the singing competition television show The Voice. Control circuitry 450 may analyze the text of these posts and/or the videos in these posts to identify the user's interest in The Voice and send a recommendation 606 to the user equipment device 300 so that the user can select to like The Voice. Control circuitry 450 may similarly analyze the user's biographical information, his contacts' likes or other information, his status postings, links he has posted, photos he has posted, videos he has posted, or any other information related to the user or his contacts to identify Recommendations 606.

The social network may allow users to set up automated messaging to their contacts. The automated messages may be based on the items they like and other information in their user profiles. FIG. 7 shows Set Up Automated Messaging screen 700, which provides selectable automated messaging setup options that a user may use to configure automated messaging.

The Set Up Automated Messaging screen 700 provides an interface with which a user can select to whom to send automated messages, a topic to which automated messages are related, and other specifications for the content and delivery of automated messages. These selections are transmitted to social network server 424 and stored as message criteria 462. A user first uses Contact Selection drop down menus 702 and 704 to select a one or more contacts to whom to send automated messages. Control circuitry 304 may receive a selection of a single contact in Select a Contact drop down menu 702. In some embodiments, user input interface 310 may allow a user to select multiple contacts in drop down menu 702. In some embodiments, user input interface 310 allows a user to select all contacts. In some embodiments, the default may be that all contacts are selected, and user input interface 702 allows the user to deselect contacts using drop down menu 702 to prevent automated messages from being sent to the deselected contacts.

Control circuitry 304 may alternatively receive a selection of a group of contacts in Select a Group drop down menu 704. Select a Group drop down menu 704 may contain one or more groups of users that the user is associated with and/or one or more groups of users that the user has created or arranged. Social network server 424 may automatically recommend groups to a user based on the user's interests 456 or other social network content associated with the user in a similar manner to the item recommendation described above in relation to FIG. 6. In some embodiments, user input interface 310 may allow a user to select multiple groups of contacts, select all groups of contacts, or deselect one or more groups of contacts in drop down menu 704. In other embodiments, user input interface 310 may provide any other mechanism for receiving a selection or deselection of one or more contacts or groups of contacts, such as a selectable list, a text entry box, etc. Until the user has entered a contact, user input interface 310 may prevent the user from selecting a topic for the automated messaging, and user input interface 310 may also or alternatively prevent the user from inputting additional messaging options.

Once control circuitry 304 receives a user selection of one or more contacts and/or group of contacts, control circuitry 304 enables the user to enter a topic for the automated messages. If the user has selected a contact from drop down menu 702, control circuitry 304 makes topic selection pane 706 active. Control circuitry 304 may transmit the contact(s) selected to social media server 424, which may reference interests 456 for each contact and transmit the contact(s) interests to user equipment device 300 for inclusion in topic selection pane 706. Control circuitry 304 may also transmit the user's interests 456 to user equipment device 300 for inclusion in topic selection pane 706. Topic selection pane 706 may include two drop down menus, the upper one for selecting an item identified as one of the contact's likes, and the lower one for selecting an item identified as one of the user's likes. If the user would like to send automated messages to the contact related to one of the contact's liked items, he may select this item in the upper drop down menu. If the user would like to send automated messages to the contact related to one of his liked items, he may select this item in the lower drop down menu. Control circuitry 304 receives either selection or selections and may send the selection to social network server 424 or store the selection until the user has completed the setup.

In some embodiments, social network server 424 may determine a user's or contact's likes and interests by analyzing any data in user database 452, using a process similar to the process described in relation to FIG. 6 for recommending items to a user. In some embodiments, the user may be able to input an item that he knows that a contact likes, even if this is not reflected in the contact's user profile. For example, if a user knows that a selected contact likes the basketball team the Los Angeles Lakers but the contact's user profile does not identify the contact's interest in the Los Angeles Lakers, the user may enter this item using, for example, a text entry box, as shown in FIG. 6.

In some embodiments, control circuitry 304 and/or social network server 424 may determine and provide a selectable list of the set of items that both the user and the contact like. In some embodiments, control circuitry 304 and/or social network server 424 may determine if any of the user's likes are opposed to or rivals with any of the contact's likes and provide a list of the rival interests which may be displayed by display 312 on Set Up Automated Messaging screen 700. If the user has selected multiple contacts, control circuitry 304 may only cause the set of items common to each of the selected contacts, a set of items common to a certain number or proportion of the selected contacts, or a set of all items liked by any of the selected contacts to be selectable.

To determine whether teams or competitors are opponents in a particular event or competition, social network server 424 may receive data identifying all competitors participating in a competition from data feed 472 or another data source. Control circuitry 450 may store this data in opponent database 470. For each competition, opponent database 470 store identifying such as competitors, date, time, location, television station covering the event, website covering the event, radio station covering the event, etc. Social network server 424 may alternatively or additionally include rival database 468 which associates teams or competitors with their rivals across multiple competitions. For example, rival database 468 may identify teams of the University of North Carolina and North Carolina State as rivals, or rival database 468 may identify the teams the Los Angeles Lakers and the Boston Celtics as rivals, since these sets of teams have been traditionally considered rivals. Control circuitry 450 may also identify rivals based on social network content. For example, if social network data indicates that half of the users who like the televised singing competition The Voice support one singer and half support a different singer, with a small number of users supporting both singers, control circuitry 450 may determine that these singers are rivals and indicate this in rival database 468.

If the user has selected a group of contacts from drop down menu 704, control circuitry 304 makes topic selection pane 708 active. The user may select to set the automated message topic as the group's common interest using the upper radio button in selection pane 708. For example, if the user selects a group identified on the social network as New York Jets fans that he belongs to, he may select the team the New York Jets as the automated message topic. In some embodiments, a group may have multiple interests, and control circuitry 304 may cause a drop down menu to be displayed by display 312 on Set Up Automated Messaging screen 700. A user may then select one of the group's interests from the drop down menu to be the automated messaging topic. As with topic selection pane 706, topic selection pane 708 may include a drop down menu one for selecting an item identified as one of the user's likes. Control circuitry 304 may cause this drop down menu to be activated if the control circuitry receives a user selection of the lower radio button. Alternatively, a selection of an item in the lower drop down menu may automatically cause the lower radio button to be selected.

In some embodiments, the social network may allow users to identify items that he dislikes. Set Up Automated Messaging screen 700 may allow a user to select one or more items that the user or the contact dislikes in a similar manner to the manner described above for selecting liked items. While herein items are referred to as being only “liked”, in some embodiments, the systems and methods disclosed herein can apply in a similar manner to disliked items, or a combination of liked and disliked items.

Once the topic for automated messaging has been selected, the user can input additional messaging options. The tone radio buttons 710 allow a user to indicate whether social network server 424 should send a message in favor of the selected item or against the selected item. For example, if both the user and the contact like the selected item, the user may select the upper radio button to indicate that message should have an approving tone (e.g., “Our team is winning!”). If the user disfavors the selected item and the contact favors the selected item, the user may select the lower radio button to indicate that the message should have a disapproving tone (e.g., “Your team is terrible!”). In some embodiments, rather than receiving tone input from the user, control circuitry 450 analyzes the interests 456 of the user and the contact to determine whether the tone should be in favor of the item or against the item. Control circuitry 450 may also or alternatively use other user profile information in user database 452 (e.g., posts on user profiles) to identify the tone that should be used. Control circuitry 450 may also or alternatively use rival database 468 or opponent database 470 described above to identify the tone that should be used.

Control circuitry 304 may also receive an indication of messaging frequency from a user selection in Frequency drop down menu 712. The frequency may indicate a minimum, average, or maximum number of messages that should be sent in a given time period. The frequency may include additional options, such as an option to only send messages on certain days, such as game days or weekends, or to send more messages on certain days and less on others. A default frequency, e.g., at most once per day, may be provided.

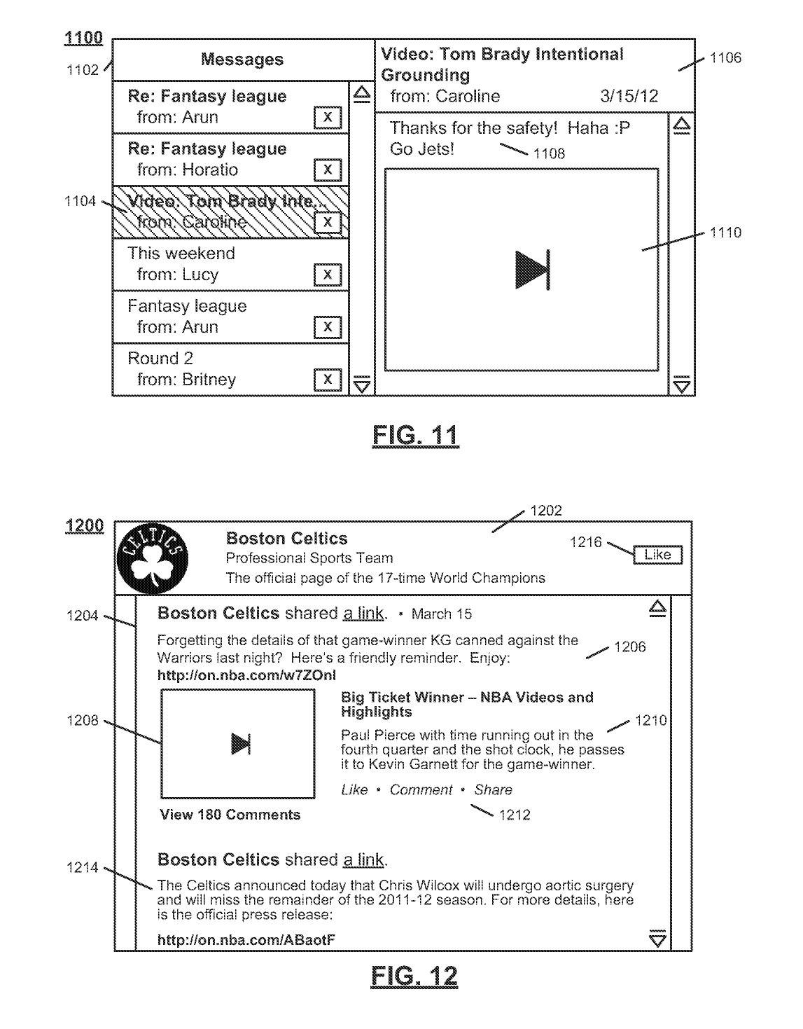

Control circuitry 304 may receive an indication of the type of automated message to send from user selections in Type of Post drop down menu 714 and Send Message Via radio buttons 716. The Type of Post drop down menu may provide options for private message types, semi-private message types, public message types, or any other message types. Send Message Via radio buttons 716 may provide various methods for sending a message, including one or more social networks (e.g., Facebook, Twitter, MySpace, Google+, etc.) and other mechanisms for sending messages to a contact (e.g., E-mail, SMS, MMS (photo messages, video messages, etc.), BBM, etc.). The mechanisms provided may be based on the contact information 462 stored in user database 452. Once the user has configured the automated messaging to his liking, he may select the Setup Complete button 718. Upon receiving a user selection of the Setup Complete button 718, control circuitry 304 sends data specifying the selected automated messaging configuration to social network server 424 which saves it as message criteria 464. Social network server 424 then generates and distributes automated messages to the contact(s) based on the received automated messaging configuration. The creation and distribution of messages is discussed in further detail in relation to FIGS. 10-16.

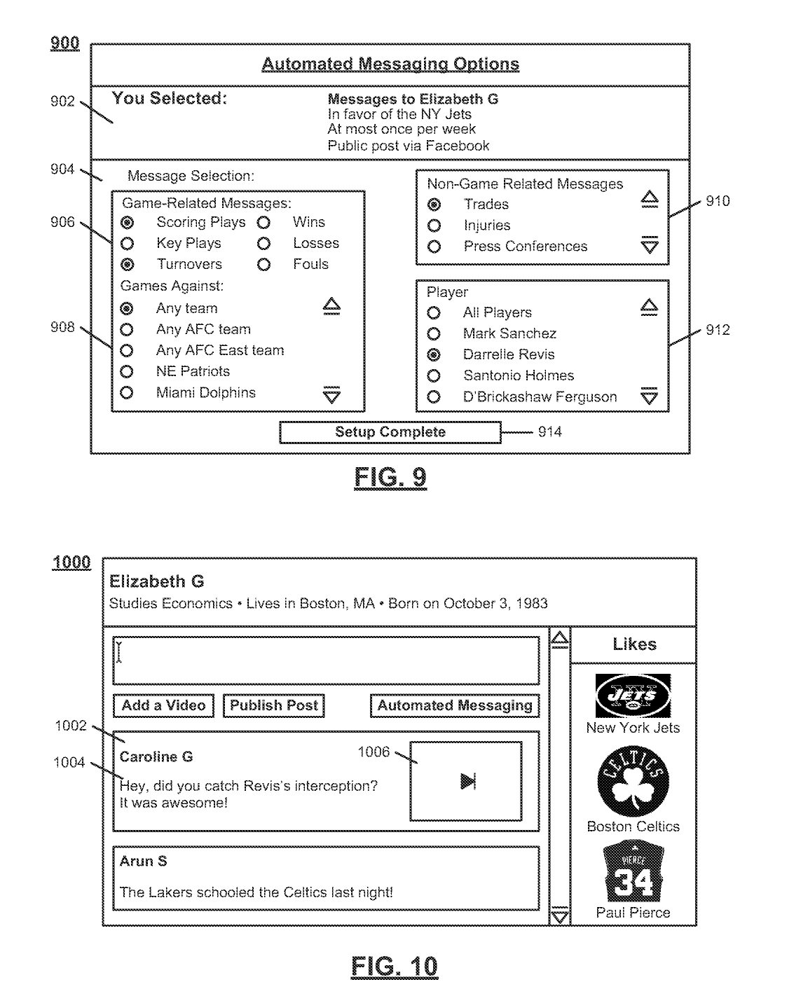

The Set Up Automated Messaging screen 700 may also provide a selectable More Options button 720. Upon receiving a user selection of the More Options button 720, control circuitry 304 displays an Automated Messaging Options screen, which may provide further options that may be based on the selections the user has made in the Set Up Automated Messaging screen 700. An exemplary Automated Messaging Options screen is described in further detail in relation to FIG. 9.

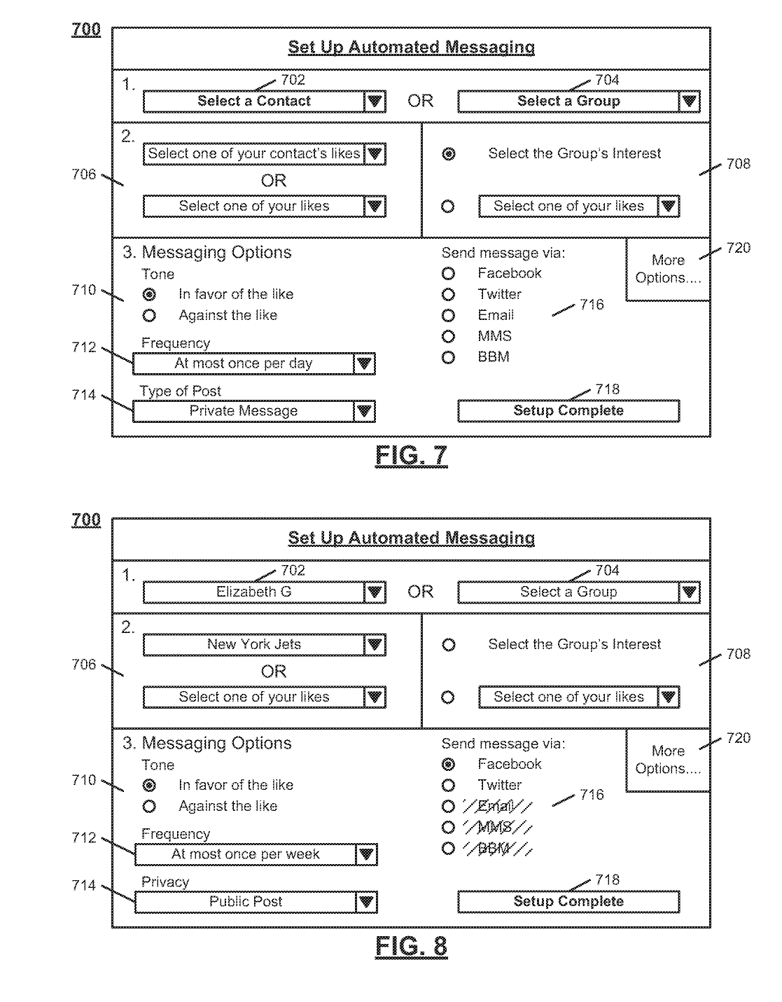

FIG. 8 shows an illustrative display screen in which a user has selected a set of automated messaging setup options in Set Up Automated Messaging screen 700. In this example, the user has selected to send messages to a contact, Elizabeth G, whose user profile was shown in FIG. 5, using drop down menu 702. The user has further selected to send automated messages related to the team the New York Jets, which is one of the contact's likes (as shown in FIGS. 5 and 6). The user has selected the tone to be in favor of the like. In this case, the user may also favor the New York Jets. The user has selected that he wants automated messages to be sent at least once per week as public posts via Facebook. In this example, Send Message Via options Email, MMS, and BBM are grayed out. The control circuitry 304 may grey out or remove certain options from the Set Up Automated Messaging screen 700 based on the user profiles or device configurations of the user and/or contact(s). In this case, the contact Elizabeth G may not have provided an email address, cell phone number, or BBM pin to the social network, and/or the user profile of the user sending the messages may not be configured or permitted by the social network to send messages via these mechanisms.

The user setting up the automated messaging may want to specify the types of messages to be sent in greater detail, so the user may select More Options button 720. Upon receiving a user selection of the More Options button 720, control circuitry 304 displays Automated Messaging Options 900 screen showing additional selectable automated messaging options. Automated Messaging Options screen includes a summary 902 of the automated messaging configuration already selected by the user. Control circuitry 450 may determine and transmit additional selectable options based on the selected configuration for displayed below the summary 902. In this example, Message Selection options 904 are selectable options for specifying the substance of the automated messages. The Message Selection options 904 may be based on the interest selected for automated messaging.

For example, if the topic is a football team (e.g., the New York Jets), the Message Selection options 904 may provide an option to send one or more types of messages related to games played by the football team. In particular, Message Selection options 904 may allow a user to select types of events in football games using Game-Related Messages radio buttons 906 to specify that social network server 424 should automatically send messages related to one or more of scoring plays, key plays, turnovers, wins, fouls, and/or injuries, and/or any other options. The Message Selection options 904 may also allow the user to select particular games using Games Against radio buttons 908 to specify that social network server 424 should send automatic messages related events in the selected games, e.g., games against any team, a certain conference or division, and/or certain teams, such as a rival or opponent identified in a rival or opponent database described above. The teams listed in Games Against radio buttons 908 may be also or alternatively based on the items liked by the user and/or the contact.

In addition to sending messages related to a particular event, the user may specify that social network server 424 should send automated messages that are not related to any particular event but may still relate to the selected interest. For example, Non-Game Related Messages radio buttons 910 may be used to specify that social network server 424 should send messages related to trades, injuries, press conferences, and/or other types of events that do not occur during football games. Further, the user may specify that social network server 424 should send automated messages related to certain players of the selected team using Player radio buttons 912. The player(s) selected using Player radio buttons 912 may limit the subject of the game-related messages, the non-game related messages, or both types of messages to events involving the selected player(s).

FIG. 10 is an illustrative display screen showing a publicly posted automated message generated based on the selectable automated messaging setup options of FIGS. 8 and 9. From the options selected by the display screen of FIG. 8, control circuitry 304 has received user selections requesting that automated messages be sent to Elizabeth G in favor of the team the New York Jets at most once per week via a public post on Facebook. From the options selected by the display screen of FIG. 9, control circuitry 304 has received user selections indicating that automated messages should relate to scoring plays or turnovers in games against any team, or that automated messages should relate to trades of players to or from the New York Jets, and that automated messages should relate to Darrelle Revis, who plays for the New York Jets. Control circuitry 304 may transmit this input to social network server 424.

Control circuitry 450 may store the automated message criteria 464 in user database 452. Control circuitry 450 may receive data identifying events from at least one data feed 472. Data feeds may include, for example, web feeds, news feeds, blog feeds, sports news feeds, product feeds, social network feeds (including content posted by users), aggregated feeds, or websites, comments, blogs, online scoreboards, comments, or other data source containing media assets or information related to events. Control circuitry 450 automatically compares the automated message criteria 464 to data from data feed 472 identifying one or more events and determines whether any event meets the criteria specified by the user responsive to receiving the data feed. If an event meets the message criteria, including the criteria that the maximum number of automated messages in a given time period (specified by the frequency) has not been reached, control circuitry 450 automatically prepares an automated message based on the event data.

The message prepared by control circuitry 450 may include text and/or a media asset, such as a video clip, audio clip, or any other social network content. A media asset may be received from asset feed 474. Data transmitted in asset feed 474 may contain event data to be used in lieu of data from data feed 472. Alternatively, control circuitry 450 may compare event data from data feed 472 to media assets from asset feed 474 to match events with media assets. Alternatively, data from the data feed may include a media asset. Data from data feed 472 and/or asset feed 474 may further include the text of a message to accompany a media asset. Alternatively, control circuitry 450 may generate a message based on the event data, the media asset, the tone specified by the user, and/or any other criteria. Message criteria 464 may specify elements to automatically include the message, such as a greeting or closing selected by the user.

In some embodiments, control circuitry 450 may send data related to a selected event to user equipment device 300 of the user. Control circuitry 304 may display an identification of the event to the user along with options for the message. After presenting the options to the user, control circuitry 304 may receive an indication of whether social network server 424 should send a message related to the event, a message written by the user, an identification of one or more additional contacts to send the message to, an identification of one or more media assets to send with the message, a time to send the method, a communication mechanism for sending the message, and/or any other message options not previously specified or that the user wants to change from the options selected in the automated messaging setup. Control circuitry 304 transmits this input to social network server 424, which generates the message according to the input.

Once control circuitry 450 has automatically generated a message, possibly based on the additional user input described above, control circuitry 450 delivers the message to the contact. The message may be delivered to the contact (e.g., by emailing the message to the contact) or may be made otherwise accessible to the user (e.g., by posting the message on a social network).

In the example shown in FIGS. 8 and 9, social network server 424 has received data from data feed 472 or asset feed 474 that it identifies as content that meets the messaging criteria inputted by the user. For example, social network server 424 may have received data identifying an interception caught by Darrelle Revis, which would lead to a turnover for the New York Jets. Control circuitry 450 determines that because the event is a turnover involving the player Darrelle Revis of the New York Jets, the event meets the subject matter criteria specified by the user and stored in message criteria 464. Control circuitry 450 also identifies whether the frequency criteria and messaging history indicates that a message should be sent. For example, if social network server 424 has not delivered a message to user Elizabeth G within the past week, control circuitry 450 will automatically generate a message for Elizabeth G according to the message delivery criteria.

FIG. 10 shows user profile display screen 1000 that includes exemplary message 1002 to Elizabeth G based on the criteria of FIGS. 8 and 9. User profile display screen 1000 is similar to user profile display screen 500, but user profile display screen 1000 includes different posts in the post region. Message 1002 identifies the sender, i.e., the user who set up the automated messaging (in this case, user Caroline G). The message 1002 further includes a media asset, in this case a video 1006, and a message discussing the event and/or the media asset. The user may receive the message 1002 when she views her user profile. In addition, social network server 424 may deliver the same message or a different automated message to the user via a second mechanism, e.g., email.

User profile display screen 1000 includes a second message from a different user (Arun S) that may have been generated by social network server 424 based on a different set of automated messaging criteria. In this case, the message is related to the team the Los Angeles Lakers, which may be one of Arun S's liked items, and the team the Boston Celtics, which is one of Elizabeth G's liked items. If the specified item for the message content were the Los Angeles Lakers, the tone specified by Arun S would have been in favor of the Los Angeles Lakers, but if the specified item for the message content were the Boston Celtics, the tone specified by Arun S would have been against the Boston Celtics. In this case, the message automatically generated by social network server 424 is text-only and does not include a media asset.

In some embodiments, the message may relate to a performance competition, such as a televised singing competition (e.g., The Voice or American Idol), a televised cooking competition (e.g., Top Chef), a televised modeling competition (e.g., America's Next Top Model), a televised dancing competition (e.g., Dancing with the Stars), etc. The competition need not be televised on broadcast TV (e.g., If I Can Dream), or may not even be a public competition (e.g., a fantasy sports league in which a group of friends participates). Any event that occurs in relation to these competitions may serve as the basis for an automatically generated message.

For example, control circuitry 450 may identify a user's interest in a competitor in Dancing with the Stars. If the selected competitor receives high scores from the judges on his performance, control circuitry 450 may automatically generate a message related to the performance and/or the scores and transmit this message to a contact that control circuitry 450 identifies as being interested in Dancing with the Stars. As another example, a user may indicate his participation in a fantasy football league. The fantasy football league may be implemented by the social network. If social network server 424 receives data indicating that user's fantasy football team has a higher score than one of his competitors in the fantasy football league, control circuitry 450 may automatically generate a message to the competitor in favor of the user's team or making fun of the competitor's team. Control circuitry 450 may automatically include a media asset in the message. The media asset may be, for example, a video showing one of the user's players making a good play or scoring points, or a video of one of the competitor's players making a bad play.

FIG. 11 shows an illustrative email message screen 1100 that displays a private message that was automatically generated by control circuitry 450 based on automated messaging criteria 464 similar to those selected in FIG. 8. In this case, however, the user had selected to send a private message via email rather than a public message via Facebook. The email message screen 1100 may include a message list 1102 and an email view region 1106. The message list 1102 may include an email message 1104 generated automatically by social network media server 424. The email message 1104 is highlighted in message list 1102 and displayed in full in email view region 1106.

As displayed in email view region 1106, the email message may include text 1108 and media asset 1110. Text 1108 may describe media asset 1110. Text 1108 and/or media asset 1110 may be selected and/or generated in the same manner as message 1002, described above. The media asset 1110 may be selected based on the tone; for example, if the tone was selected to be in favor of the selected item, the selected media asset 1110 should relate to an event that is favorable to fans of the selected item. Alternatively, if the tone was selected to be against the selected item, media asset 1110 should relate to an event that is disfavorable to fans of the selected item. In the example shown in FIG. 11, text 1108, which is in favor of the team New York Jets and is related to a scoring play (a safety), mocks Tom Brady, who plays for the New England Patriots, for making a play that was bad for his team and good for the New York Jets, such as intentional grounding in the end zone. Tom Brady's intentional grounding scored points for the New York Jets. The media asset 1110 may be a video of the intentional grounding.

Additional data sources from which social network server 424 may receive events for automated messages include pages on the social network. Social network users may post or publish social network content related to events, and control circuitry 450 may generate automated messages from this social network content. FIG. 12 is an illustrative user profile display screen 1200 including published social network content that social network server 424 may use to generate automated messages. User profile display screen 1200 displays the user profile of the basketball team the Boston Celtics. User profile display screen 1200 includes biographical information 1202, which includes information identifying and describing the Boston Celtics, and post region 1204.

Post region 1204 includes posts published by the Boston Celtics relating to Boston Celtics games and other events that relate to the team. The top post in post region 1204 is a video relating to a game against another team, the Golden State Warriors. The post includes a description of the post 1206, and, as shown in FIG. 12, may contain a link to the video. The post also includes embedded video 1208 of the event mentioned in the description: a game winning score made by Kevin Garnett, who plays for the Boston Celtics. The post also includes media asset description 1210, which, in this example, describes the video.

The post may have selectable interaction options 1212 with which a user can interact with the post. As shown in FIG. 12, a user can indicate that he likes the post, wants to comment on the post, or wants to share the post with his contacts. If control circuitry 304 of a user equipment device 300 receives a like selection, a comment, or a share selection, it may display an interface to receive additional information from the user (e.g., the text of a comment or a selection of one or more contacts to share the post with). Control circuitry 304 then sends data related to the user action to social network server 424. After control circuitry 450 receives the post data and stores it in posts 460 or as separate interaction data, control circuitry 450 may transmit data for displaying the interaction to control circuitry 304, which displays the interaction.

Post region 1204 may contain at least a second post below the top post. The second post shown in FIG. 12 is related to an injury of a Boston Celtics player and contains a description of the event and a link for more information. This post may also contain a media asset and/or selectable interaction options 1212.

User profile display screen 1200 may also include a Like button 1216 that a user can select to indicate that he likes the user profile; in this case, selecting the Like button indicates that the user likes the Boston Celtics. In some embodiments, the user profile display screen 1200 may also include a dislike button or other button or mechanism for receiving a user's opinion of the user profile. Upon receiving a selection of Like button 1216, control circuitry 304 sends data indicating the user selection to social network server 424. The liked user profile may then be stored in interests 456 and appear as a liked item in the user's user profile.

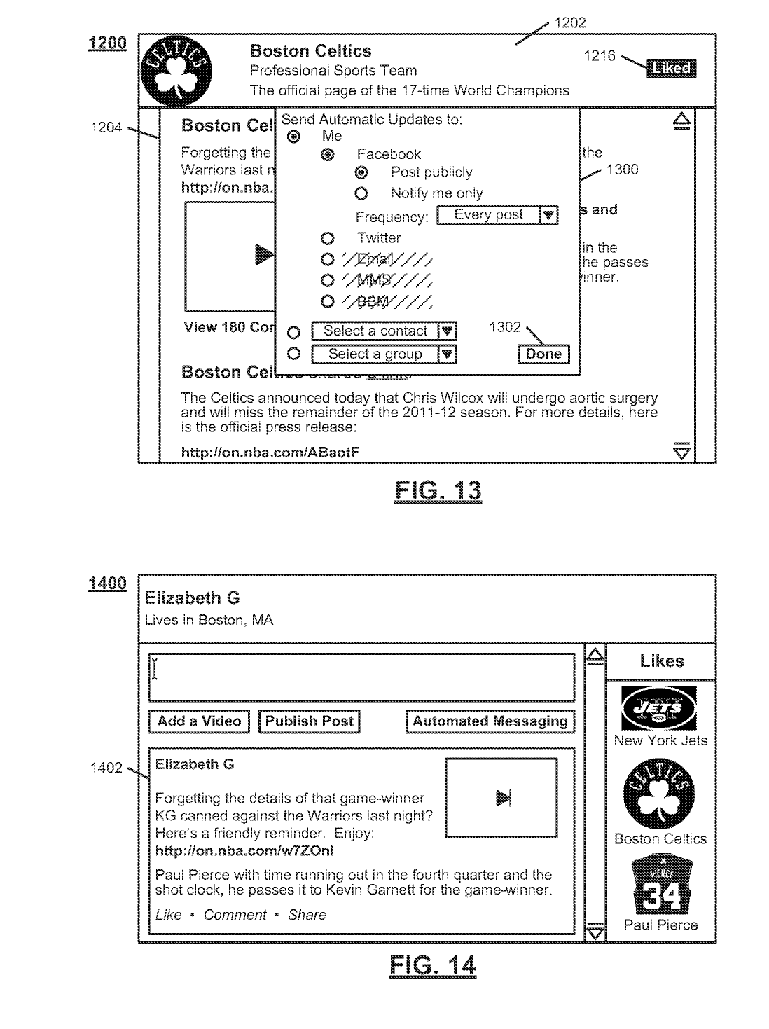

Receiving a selection of the Like button 1216 may also cause control circuitry 304 to provide an interface with which the user can set up automated messaging related to the liked user profile. This interface may be provided by social media server 424. An exemplary automated updates overlay 1300 is depicted in FIG. 13 as an overlay on user profile display screen 1200. FIG. 13 also shows that control circuitry 304 sent the Like selection to social network server 424, causing control circuitry 304 to modify the Like button 1216 to indicate that the user profile has been liked by the user.

Automated updates overlay 1300 is depicted as providing tiered selection with radio buttons. A user first identifies one or more recipient users to receive automated updates related to the liked user. As shown, automated messaging overlay 1300 allows the user to have automatic updates sent to himself, a contact, or a group of contacts. In some embodiments, the automated updates overlay 1300 allows a user to set up automated updates to users from multiple categories (e.g., to himself and to a group). Upon receiving a user selection of the recipient, control circuitry 304 displays a second messaging option, such as a mechanism for sending the update. As shown in FIG. 13, the user has selected to send the message to himself via Facebook. Additional tiers of selectable options may be displayed, e.g., frequency of updates and privacy of the messages. Automated updates overlay 1300 may also provide options to send updates relating to certain message subject matter, as described in relation to FIG. 9, to provide a tone for the update messages, or any other options. As shown in FIG. 13, the user has selected to publicly post every update from the Boston Celtics to his Facebook profile.

When a user has entered the options for the automated updates overlay 1300 to his liking, he may click Done button 1302. Upon receiving the selection of Done button 1302, control circuitry 304 transmits the user's automated update preferences to social network server 424. Control circuitry 450 may store the preferences in message criteria 464. Based on message criteria 464, control circuitry 450 may generate and deliver messages or updates to the specified recipient(s) when the liked user posts social network content to his user profile. The social network server 424 may deliver a message to a specified recipient every time the liked user posts social network content, for selected types of posted content, for a specified proportion of the posts, for a specified number of posts in a given time period, or based on any other criteria or combination of criteria.

FIG. 14 shows user profile display screen 1400 that includes a publicly posted automated message 1402 generated based on the selectable automated messaging setup options of FIG. 13. User profile display screen 1400 is similar to user profile display screen 500, but user profile display screen 1400 includes a different post in the post region. According to the criteria entered in automated updates overlay 1300, when social network server 424 receives a new post from the Boston Celtics, control circuitry 450 determines based on message criteria 464 that it should deliver the Boston Celtic's new post to the user profile of Elizabeth G. When Elizabeth G or another user (e.g., one of her contacts) views her page, their user equipment devices 300 receive the post from social network server 424 and may display the post as shown in FIG. 14.

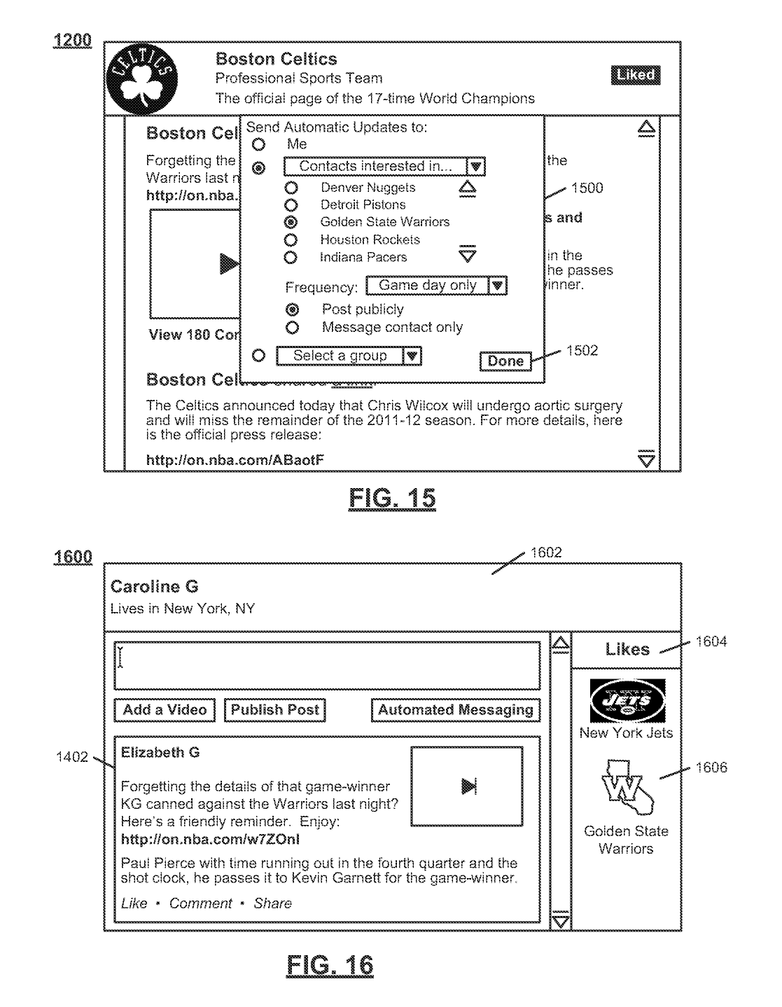

FIG. 15 is an illustrative display screen showing automated updates overlay 1500, which is similar to automated updates overlay 1300 but with different criteria for automated updates inputted by the user. In this case, the user has indicated that automated updates from the Boston Celtic's posts should be sent to contacts that are interested in the basketball team the Golden State Warriors, on game day only, and to post the updates publicly. Social network server 424 may send all updates about the Boston Celtics to the selected contacts, or social network server 424 may only send updates that also relate to the recipients' interest(s). For example, contacts interested in the Golden State Warriors may receive only the updates that relate to Boston Celtics games against the Golden State Warriors. Unlike automated updates overlay 1300, automated updates overlay 1500 does not include selectable mechanisms for delivering the update. The default mechanism may be delivery via the social network offering the automated messaging. In some embodiments, other delivery mechanism options are provided.

Upon receiving the user input entered via automated updates overlay 1500 from control circuitry 304, control circuitry 450 may compare the interest(s) identified by the user input (here, the Golden State Warriors) and stored as message criteria 464 to the interests 456 of the user's contacts. Based on the comparison, control circuitry 450 may determine one or more contacts having an interest specified by the user input. When control circuitry 450 finds a match between a contact's interests and an event, control circuitry 450 may send a message about the event to the contact. In the example shown in FIG. 15, when control circuitry 450 determines that a post to the Boston Celtics profile relates to the Golden State Warriors, control circuitry 450 automatically sends an update to any contact who likes the Golden State Warriors.

FIG. 16 is a user profile display screen 1600 which includes a publicly posted automated message generated based on the selectable automated messaging setup options of FIG. 15. User profile display screen 1600 is similar to user profile display screen 1400 and contains the same post 1402, but the user profile displayed is the user profile for Caroline G, one of Elizabeth G's contacts who likes the Golden State Warriors. Like region 1604 contains Caroline G's liked items, the New York Jets and the Golden State Warriors 1606. While post 1402 on user profile display screens 1400 and 1600 are both shown as being identical to the post on the Boston Celtic's user profile, in other embodiments, the content and/or the format of the post may be tailored to the recipient.

In other embodiments, the user may not specify criteria for choosing a contact to send an automated message to, but rather, control circuitry 450 identifies criteria for choosing a contact based on the user's contacts' interests 456 and event data from data feed 472, asset feed 474, posts from users, or other data sources. For example, if the user indicated an interest in sending automated messages related to any contact who is interested in one of the Boston Celtic's posts, control circuitry 450 may identify which contact(s) would be interested based on each of the posts. For example, if the Boston Celtics posted social network content about the Los Angeles Lakers, control circuitry 450 may identify all of the user's contacts that are interested in the Los Angeles Lakers and automatically generate a message to send to the contact(s). In some embodiments, control circuitry 450 only sends content that is favorable to the user or disfavored by the contact. The message may have a tone that is against the Los Angeles Lakers, since the Boston Celtics, who the user favors, are a rival of the Los Angeles Lakers, as may be indicated by a database identifying rival teams. Control circuitry 450 would send this message to the selected contact or contacts.

FIGS. 17 through 19 illustrate processes for setting up, generating, and transmitting automated messages. An application on user equipment device 300, social network server 424, and/or a remote application may instruct processing circuitry to perform any of the functions described in relation to FIGS. 17 through 19.

FIG. 17 shows an illustrative process 1700 for setting up criteria for generating automated messages to send to contacts. The process includes steps for receiving a contact, an interest, and message options for configuring automated messaging. The process 1700 may be carried out by social network server 424 in communication with user equipment device 300, which displays user input interfaces such as those shown in FIGS. 7 through 9, FIG. 13, and/or FIG. 15, or other suitable user interfaces.

Control circuitry 304 in a user device receives from user input interface 310 user input indicating one or more contacts and/or one or more groups of contacts to whom to send automated messages, as described in relation to FIG. 7. For example, as shown in FIG. 8, control circuitry 304 may receive a user selection of contact Elizabeth G. Control circuitry 304 transmits data identifying the contacts to social network server 424, which receives the user selection of the contact or contacts (step 1702). Based on the contact or contacts selected, control circuitry 450 identifies the interests of the contact or contacts by referencing social network content associated with the contact in user database 452, as described in relation to FIG. 7 (step 1704). Control circuitry 450 transmits the interests to the control circuitry 304 for display on display 312 of user equipment device 300 (step 1706). The interests of the user may also be similarly identified by control circuitry 450 and transmitted to the control circuitry 304 for display on display 312 of user equipment device 300.

Control circuitry 304 then receives from user input interface 310 user input indicating one or more interests of the contact(s) and/or the user, as described in relation to FIG. 7 (step 1710). For example, control circuitry 304 may present interests in a drop down menu and receive a selection of an interests, such as the football team New York Jets, as shown in FIG. 8. Control circuitry 304 transmits data identifying the interest(s) to social network server 424, which receives the user selection of the interest(s) (step 1708). Control circuitry 450 then identifies messaging options (step 1710). Messaging options, such as those described in relation to FIGS. 7 and 8, may be based on the selected contact(s) and/or selected interest(s). For example, a delivery mechanism option may be based on the contact information that is available on a contact's user profile. Substantive messaging options, such as type of event related to an interest, may be based on the selected interest, as described in relation to FIG. 9. Other options, such as messaging frequency and message privacy, may not be based on the selected contact(s) or interest(s).

Control circuitry 450 transmits these messaging options to control circuitry 304 for display on display 312 of user equipment device 300 (step 1712). If any options are not based on the selected contact(s) and/or interest(s), the options may be displayed before the contact(s) and/or interest(s) are selected. Control circuitry 304 then receives from user input interface 310 user input indicating the message options selected by the user, as described in relation to FIGS. 7 and 9 (step 1714). Control circuitry 450 stores the user selections of the message criteria, including the contact(s) receive in step 1702, the interest(s) received in step 1708, and the message options received in step 1714, in message criteria 464 (step 1716)

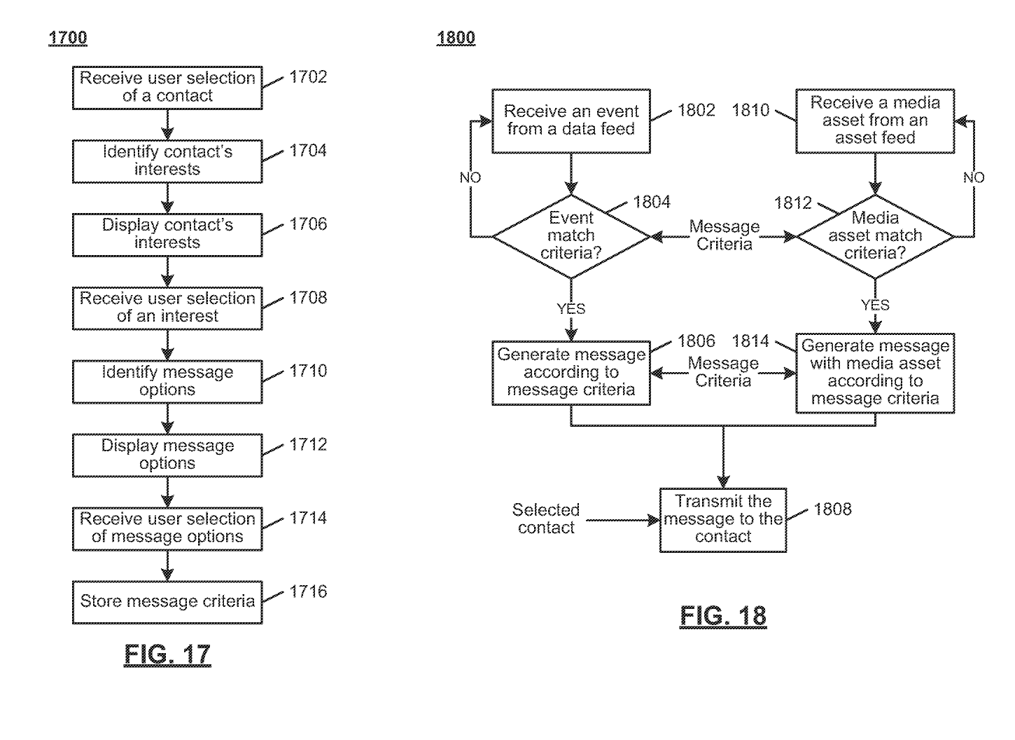

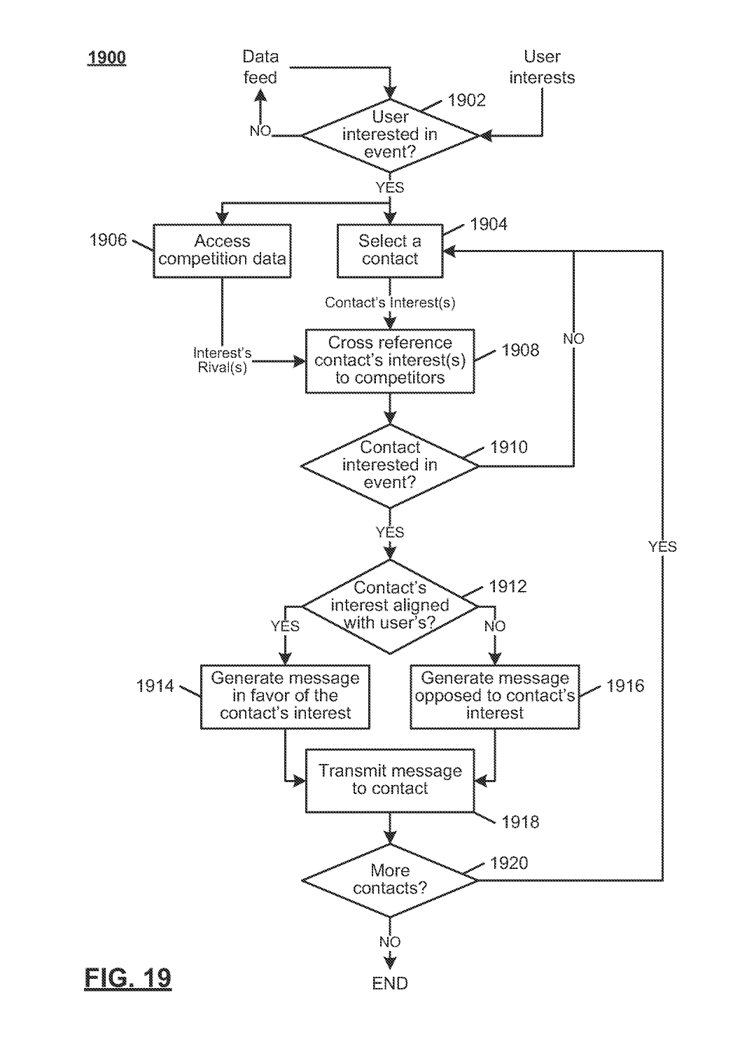

Once social network server 424 has received user input to configure automatic messaging by process 1700, control circuitry 450 generates messages to contacts based on the configurations and transmits the messages to the contacts, as shown in process 1800 of FIG. 18. Social network server 424 receives data related to an event from one or more data feeds 472 (step 1802). Data feeds may include, for example, web feeds, news feeds, blog feeds, sports news feeds, product feeds, social network feeds (including content posted by users), aggregated feeds, or websites, comments, blogs, online scoreboards, comments, or other data source containing data related to events.

Control circuitry 450 compares data related to an event in the data feed to the user selection of the interest to determine whether the event matches the message criteria received in process 1700 (decision 1804). If the event does not match the message criteria, control circuitry 450 receives the next event from data feed 472 (step 1802) and compares this event to the message criteria. If the event does match the message criteria, social network server generates a message according to the message criteria (step 1806). In some embodiments, the user in step 1708 selects two or more interests. If multiple interests are selected, social network server 424 may automatically generate messages if the event relates to one of the selected interests, a threshold number or proportion of the selected interests, or all of the selected interests.

Control circuitry 450 may generate a message as described in respect to FIGS. 10, 11, 14, and 16. The message content, tone, and format may be based on the message criteria received in process 1700. Control circuitry 450 transmits the generated message to the selected contact identified in process 1700 (step 1808). Control circuitry 450 may transmit the message by a public posting on a social network, a private message though a social network, an email, an MMS, or any other mechanism.

In some embodiments, the interest may be engaged in a competition, such as a game or television contest. In this case, the steps of the method include receiving a user selection of a competitor, identifying a media asset associated with the competitor, identifying a contact with an interest in the competition (e.g., an interest in one of the competitors of the competition or an interest in the television contest), which in some embodiments may involve looking up data in rival database 468 and/or opponent database 470, and transmitting a message containing the media asset to the contact.

Parallel to the subprocess of steps 1802-1806 is similar subprocess (steps 1810-1814) for generating a message containing a media asset. Social network server 424 receives a media asset from one or more asset feeds 474, which are data feeds, such as those described above, that include media assets (step 1810). The media asset may be associated with identifying data, such as parties depicted in the media asset (e.g., sports teams, athletes, performers, or other competitors). For example, social network server 424 may receive from asset feed 474 data identifying an interception caught during a football game by Darrelle Revis, a player for the New York Jets, and a media asset associated with this interception, such as a video or photo of Darrelle Revis catching the football.

Control circuitry 450 then compares the data related to the media asset to the message criteria to determine whether the received media asset matches the message criteria (step 1812). For example, the data identifying the interception matches the message criteria of FIG. 9 that sets up automated messaging for events related to the New York Jets that are also related to turnovers and that involve Darrelle Revis.

If the media asset does not match the message criteria, social network server 424 receives the next media asset from the media asset feed (step 1810) and compares this media asset to the message criteria. If the media asset does match the message criteria, social network server 424 generates a message containing the media asset according to the message criteria (step 1812). An exemplary public posting on a social network that includes a media asset related to Darrelle Revis's interception is shown in FIG. 10. These steps and any variations or additions to the steps may be similar to steps 1802-1806 discussed above, with the exception that a media asset is received and included in the message. If a message is generated with a media asset, it is transmitted to the selected contact (step 1808).

FIG. 19 shows another illustrative process 1900 for generating and sending a message to a contact of a user of a social network. Process 1900 relies on less user configuration and more on information stored on the social network to generate messages related to events or media assets and send the messages to a user's contacts.

Control circuitry 450 receives data and/or media assets from data feed 472 and/or asset feed 474, as described in relation to FIG. 18. The data or media asset may be related to an event. Control circuitry 450 compares the event from the data feed to the user's interests 456 or other data in user database 452 to determine whether the user would be interested in the event (decision 1902). This decision is similar to decisions 1804 and 1812 in FIG. 18, but for decision 1902, social network server 424 may rely only or more heavily on social network data, rather than automated messaging setup selections, to determine the user's interests and, from this, whether he would be interested in the event. For example, if control circuitry 450 receives a video clip from the television show The Voice in which Jamar, a contestant on The Voice, is singing, control circuitry 450 may compare data associated with video clip to posts in user database 452, such as posts 512 and 516 shown in FIG. 5, to determine that the user would be interested in the video clip.

If the user is not interested in the event, social network server 424 receives the next event in the data feed and continues the process. If the user is interested in the event, control circuitry 450 selects one of the user's contacts 454 (step 1904) and identifies or determines the contact's interests 456 from user database 452 as described in relation to FIGS. 6 and 7. Control circuitry 450 also accesses competition data that may be sent with the event data or retrieved from opponent database 470, which identifies which competitors are involved in the competition (step 1906). Competition data may indicate which competitors are opposed to each other or rivals with each other. In some embodiments, competition data includes data from rival database 468, which indicates one or more competitors that are rivals with a competitor the user is interested in. Control circuitry 450 may determine whether any of these rivals are involved in the competition. For example, control circuitry 450 may access opponent database 470 to identify Jamar's opponent on the episode of The Voice that contains the video clip.

Control circuitry 450 then cross-references the contact's interests to the competitor data (step 1908) to determine whether the contact would be interested in the event (decision 1910). The contact may be interested in the event if the contact is interested in the user's interest (e.g., a competitor favored by the user) or if the contact is interested in an opponent of the user's interest. For example, control circuitry 450 may identify a contact who likes Jamar or a contact who likes Jamar's opponent in the episode of The Voice. If the contact is not interested in the event, social network server 424 selects another one of the user's contacts.

If the contact is interested in the event, social network server 424 determines whether the contact's interest is aligned with the user's interest (decision 1912). This decision may be based on the competition data accessed in step 1906. For example, if the event is a sports game, control circuitry 450 determines whether the user and the contact would be rooting for the same team or for opposing teams based on the competition data. If the contact's interest is aligned with the user's interest, control circuitry 450 generates a message that is in favor of the contact's interest (step 1914). For example, if the contact is also interested in Jamar, control circuitry 450 generates a message that is in favor if Jamar. If the contact's interest is not aligned with the user's interest, social network server 424 generates a message that is opposed to the contact's interest and in favor of the user's interest (step 1916). For example, if the contact is interested in Jamar's opponent, control circuitry 450 may generate a message indicating that Jamar's opponent is inferior to Jamar. The message generated in step 1914 or step 1916 may contain a media asset related to the event.

Once the message has been generated, control circuitry 450 transmits the message to the contact in a manner similar to step 1808 of FIG. 18 (step 1918). Control circuitry 450 then identifies whether the user has more contacts to potentially message (decision 1920). If the user has more contacts, control circuitry 450 returns to step 1904 and selects another contact. Otherwise, the process 1900 ends.

As described in FIGS. 7, 8, 9, 13, and 15, and process 1800, messages generated and sent via process 1900 may be subject to message criteria 464 specified by the user. For example, a user may specify certain users to consider sending automated messages or certain users never to send automated messages. A user may specify messaging frequency or times of day to message. A user may specify certain message topics or data feeds to source events or media assets. For example, a user may specify that automated messages only be sent for media assets posted by espn.com or to certain user profiles on a social network.

It should be understood that the above steps of the flow diagrams of FIGS. 17-19 may be executed or performed in any order or sequence not limited to the order and sequence shown and described in the figures. Also, some of the above steps of the flow diagrams of FIGS. 17-19 may be executed or performed substantially simultaneously where appropriate or in parallel to reduce latency and processing times.

The above-described embodiments of the present disclosure are presented for purposes of illustration and not of limitation, and the present disclosure is limited only by the claims which follow.

1. A method for sending a communication to a contact in a social network, the method comprising:
receiving a user selection identifying a competitor involved in a competition from a user of the social network;
automatically identifying, by control circuitry, a media asset associated with the competitor identified by the user selection;
identifying, by control circuitry, a contact of the user in the social network with an interest in the competition using data stored on the social network; and
automatically transmitting, by communications circuitry, the identified media asset to the identified contact.

2. The method of claim 1, wherein the competitor identified by the user selection is opposed to the interest of the contact, the method further comprising:
determining, from data associated with the media asset, that the media asset is desirable to the user and is undesirable to the contact.

3. The method of claim 1, wherein the competitor identified by the user selection is the same as or is aligned with the interest of the contact, the method further comprising:
determining, from data associated with the media asset, that the media asset desirable to both the user and the contact.

4. The method of claim 1, wherein the competitor identified by the user selection is one of a sports team and an athlete, and the identified media asset is a video clip of the competition involving the competitor.

5. The method of claim 1, further comprising:
automatically generating a message pertaining to the identified media asset; and
automatically transmitting, by the communications circuitry, the message pertaining to the identified media asset to the contact.

6. The method of claim 5, wherein content of the message pertaining to the identified media asset is based on whether the interest of the contact is the same as, aligned with, or opposed to the competitor identified by the user selection.

7. The method of claim 1, wherein the contact is associated with a group that shares the interest of the contact, and transmitting the identified media asset to the contact comprises transmitting the identified media asset to the group.

8. The method of claim 1, further comprising automatically selecting the contact from a plurality of contacts of the user in the social network, wherein automatically selecting the contact comprises:
comparing competitors in which the plurality of contacts are interested to the competitors involved in the competition, wherein each of the competitors in which the plurality of contacts are interested may or may not be involved in the competition; and
selecting a contact that is interested in a competitor involved in the competition.

9. The method of claim 1, the wherein identifying the interest of the contact comprises performing text analytics on text that the social network associates with the contact.

10. The method of claim 1, further comprising identifying the competition in which the competitor identified by the user selection is involved by:
receiving a data feed comprising data related to a plurality of competitions;
comparing the competitors of each of the plurality of competitions to the competitor identified by the user selection; and
selecting, from the plurality of competitions, a competition in which the competitor identified by the user selection is involved.

11. A system for sending a communication to a contact in a social network, the system comprising:
control circuitry configured to:
receive a user selection identifying a competitor involved in a competition from a user of the social network;
automatically identify a media asset associated with the competitor identified by the user selection; and
identifying a contact of the user in the social network with an interest in the competition using data stored in a database of the social network; and
communications circuitry in communications with the control circuitry to automatically transmit the identified media asset to a user device of the identified contact.

12. The system of claim 11, wherein the competitor identified by the user selection is opposed to the interest of the contact, and the control circuitry is further configured to:
determine, from data associated with the media asset, that the media asset is desirable to the user and is undesirable to the contact.

13. The system of claim 11, wherein the competitor identified by the user selection is the same as or is aligned with the interest of the contact, and the control circuitry is further configured to:
determine, from data associated with the media asset, that the media asset desirable to both the user and the contact.

14. The system of claim 11, wherein the competitor identified by the user selection is one of a sports team and an athlete, and the identified media asset is a video clip of the competition involving the competitor.

15. The system of claim 1, wherein:
the control circuitry is further configured to automatically generate a message pertaining to the identified media asset; and
the communications circuitry is further configured to automatically transmit the message pertaining to the identified media asset to the user device of the contact.

16. The system of claim 15, wherein content of the message pertaining to the identified media asset is based on whether the interest of the contact is the same as, aligned with, or opposed to the competitor identified by the user selection.

17. The system of claim 11, wherein the contact is associated with a group that shares the interest of the contact, and transmitting the identified media asset to the contact comprises transmitting the identified media asset to the group.

18. The system of claim 11, wherein the control circuitry is further configured to automatically select the contact from a plurality of contacts of the user in the social network by:
comparing competitors in which the plurality of contacts are interested to the competitors involved in the competition, wherein each of the competitors in which the plurality of contacts are interested may or may not be involved in the competition; and
selecting a contact that is interested in a competitor involved in the competition.

19. The system of claim 11, the wherein identifying the interest of the contact comprises performing text analytics on text that the social network associates with the contact.

20. The system of claim 11, wherein the control circuitry is further configured to identify the competition in which the competitor identified by the user selection is involved by:
receiving a data feed comprising data related to a plurality of competitions;
comparing the competitors of each of the plurality of competitions to the competitor identified by the user selection; and
selecting, from the plurality of competitions, a competition in which the competitor identified by the user selection is involved.

21-30. (canceled)
